(19) United States
(12) Patent Application Publication
(10) Pub. No.: US 2026/0321726 A1
(43) Pub. Date: Oct. 15, 2026

(54) ELECTROLYTE ADDITIVES FOR IMPROVING CYCLING PERFORMANCES OF SODIUM-ION BATTERIES

(71) Applicant: Nanyang Technological University, Singapore (SG)

(72) Inventors: Jun PAN, Singapore (SG); Qingyu YAN, Singapore (SG); Madhavi SRINIVASAN, Singapore (SG)

(21) Appl. No.: 19/575,655

(22) Filed: Mar. 23, 2026

(30) Foreign Application Priority Data
Apr. 15, 2025 (SG) 10202500987V

(51) Int. Cl. H01M 10/0567; H01M 4/04; H01M 4/505; H01M 4/525; H01M 10/054; H01M 10/0569

(52) U.S. Cl. CPC H01M 10/0567; H01M 4/0404; H01M 4/505; H01M 4/525; H01M 10/054; H01M 10/0569

(57) ABSTRACT

Herein disclosed is an electrolyte for use in a battery comprising: an electrolyte salt; a solvent; and a nitrogen-containing Lewis base additive having a stronger electron-donating ability than the solvent. A method for forming the electrolyte, a battery comprising the electrolyte, and a method for forming the battery, are disclosed herein.

### CROSS-REFERENCE TO RELATED APPLICATION

This application claims the benefit of priority of Singapore Patent Application No. 10202500987V, filed 15 Apr. 2025, the content of which is hereby incorporated by reference in its entirety.

### TECHNICAL FIELD

The present disclosure relates to an electrolyte for use in a battery and a method for forming the electrolyte. The present disclosure also relates to a battery comprising the electrolyte and a method for forming the battery.

### BACKGROUND

Compared to lithium-ion batteries (LIBs), which may offer high energy density, sodium-ion batteries (SIBs) may show significant potential for large-scale stationary energy storage applications due to their cost efficiency and greater sustainability. Consequently, achieving a long cycle life may have become one of the most critical performance indicators. In SIBs, hard carbon tends to be recognized as a suitable anode material due to its cost-effectiveness and stability. Meanwhile, ester-based electrolytes are favored in the industry due to their ability to withstand voltages up to 4.5 V, making them suitable for high-voltage sodium-ion battery systems. However, side reactions occur when the battery is charged to 4 V, leading to poor cycle stability, of which the transition metal-containing cathode may bear significant responsibility for this issue. Therefore, identifying the causes of battery lifetime reduction associated with the cathode may be one consideration.

To date, extensive research may have been conducted on SIB cathodes, however, in-depth research on failure analysis during cycling appears to remain insufficient. In a traditional example, it was demonstrated that the degradation of electrochemical performance in Na_{2/3}Ni_{1/3}Mn_{2/3}O₂ is attributed to its surface-side reactions and the dissolution of transition metals. In another traditional example, identified vanadium dissolution and associated parasitic reactions were reported as the causes of failure in Na₃V₂(PO₄)₂F₃//hard carbon batteries. In another traditional example, investigation on the failure mechanisms of layered oxide//hard carbon sodium-ion pouch cells with various voltage cut-offs were carried out and attributed the failures to increased impedance and sodium metal plating. All these traditional studies appear to merely propose that cycling stability can be enhanced through interface engineering strategies, such as applying protective coatings or optimizing electrolyte composition. However, these approaches tend to lack systematic theoretical frameworks to provide clear guidelines for modifying material structures, limiting their scalability.

### SUMMARY

In a first aspect, there is provided an electrolyte for use in a battery comprising:
an electrolyte salt;
a solvent; and
a nitrogen-containing Lewis base additive having a stronger electron-donating ability than the solvent.

In another aspect, there is provided a method for forming the electrolyte described in various embodiments of the first aspect, the method comprising mixing the electrolyte salt and the nitrogen-containing Lewis base additive in the solvent.

In another aspect, there is provided a battery comprising:
an anode;
a cathode comprising sodium and a transition metal oxide, wherein the transition metal oxide comprises iron; and
an electrolyte described in various embodiments of the first aspect.

In another aspect, there is provided a method for forming the battery described in one or more aspects mentioned above, the method comprising:
forming the anode;
forming the cathode;
forming the electrolyte described in various embodiments of the first aspect; and
assembling the anode, the cathode, and the electrolyte configured between the anode and the cathode, to form the battery.

### BRIEF DESCRIPTION OF THE DRAWINGS

The drawings are not necessarily to scale, emphasis instead generally being placed upon illustrating the principles of the present disclosure. In the following description, various embodiments of the present disclosure are described with reference to the following drawings, in which:

FIG. 1 is a table listing 61 additives are selected through the Reaxys database and the properties. The compounds in italics font are commercially available. They are divided into three categories: amino sodium salt (C₂F₆NNaO₄S₂ and F₂NNaO₄S₂), imine sodium salt (C₆H₁₈NNaSi₂), and cyclic derivatives (C₂H₃N₃Na and C₁₉H₁₇N₂NaO₄S). Considering the price and stability during the electrochemical reaction, C₆H₁₈NNaSi₂ (traditionally not used as a sodium-ion battery additive) and C₂F₆NNaO₄S₂ are selected for further investigation.

FIG. 2 shows composition characterization of NFMNO (NaFe_{1/3}Mn_{1/3}Ni_{1/3}O₂₎. Left image shows XRD pattern (10 denotes the vertical axis in intensity (a.u.) and 20 denotes the horizontal axis in 2θ degree). Right image shows a corresponding table of the elemental composition from EDS (energy-dispersive X-ray spectroscopy) spectrum.

FIG. 3 shows SEM images of NFMNO.

FIG. 4 shows an SEM image and the corresponding elemental mapping of the NFMNO.

FIG. 5A relates to electrochemical performance and changes in NFMNO and electrolytes. FIG. 5A plots the number of deintercalated ions-voltage at the first cycle. 51 denotes the vertical axis for voltage in V vs. Na⁺/Na. 52 denotes the horizontal axis for x in Na₁₋ₓFe_{1/3}Mn_{1/3}Ni_{1/3}O₂.

FIG. 5B relates to electrochemical performance and changes in NFMNO and electrolytes. FIG. 5B plots the CV measurement at 0.2 mV s⁻¹. 53 denotes the vertical axis for current in mA. 54 denotes the horizontal axis for voltage in V.

FIG. 5C relates to electrochemical performance and changes in NFMNO and electrolytes. FIG. 5C plots the galvanostatic charge-discharge cycling performance and Coulombic efficiency (1 C=100 mAh g⁻¹). 55 denotes the left vertical axis for capacity in mAh g⁻¹. 56 denotes the horizontal axis for cycle number. 57 denotes the right vertical axis for Coulombic efficiency in %.

FIG. 5D relates to electrochemical performance and changes in NFMNO and electrolytes. FIG. 5D plots transition metal ion content in the electrolyte after 100 cycles. 58 denotes the vertical axis for contents in mg/L.

FIG. 5E relates to electrochemical performance and changes in NFMNO and electrolytes. FIG. 5E plots the normalized X-ray absorption near edge structure (XANES) spectra of Ni K-edges at different states with the corresponding metal oxide powders as standard references. 59 denotes the vertical axis for normalized χμ in E. 60 denotes the horizontal axis for energy in eV.

FIG. 5F relates to electrochemical performance and changes in NFMNO and electrolytes. FIG. 5F plots the normalized X-ray absorption near edge structure (XANES) spectra of Fe K-edges at different states with the corresponding metal oxide powders as standard references. 61 denotes the vertical axis for normalized χμ in E. 62 denotes the horizontal axis for energy in eV.

FIG. 5G relates to electrochemical performance and changes in NFMNO and electrolytes. FIG. 5G plots the ¹H NMR of the electrolytes at different cycles (top: OCV; middle: 3^{rd} cycle; bottom: 100^{th} cycle). 63 denotes f1 (ppm).

FIG. 6A shows XPS spectra of Mn 2p in NFMNO material (64 denotes the vertical axis for intensity (a.u.), 65 denotes horizontal axis for binding energy in eV).

FIG. 6B shows normalized X-ray absorption near edge structure (XANES) spectra of Mn K-edges at different states in NFMNO//Na cell with the corresponding metal oxide powders as standard references (66 denotes vertical axis for normalized χμ in E, 67 denotes horizontal axis for energy in eV).

FIG. 7 relates to NMR spectra analysis. The top image is a plot of ¹H NMR of PC. The center image is a plot of ¹H NMR of FEC. The bottom image is a plot of ¹H NMR of 1 M NaPF₆ in EC/DEC/PC+5%FEC electrolyte. 700 denotes PC, 702 denotes FEC, 704 denotes 1 M NaPF₆ in EC/DEC/PC+5% FEC, 70 denotes f1 (ppm). 700a denotes CH in PC, 700b denotes CH₂ in PC, 700c denotes CH₃ in PC. 702a denotes CH₂ in FEC, 702b denotes CH in FEC, 702c denotes H in H₂O, 702d denotes CH₃ in DMSO. 704a denotes CH₂ in FEC, 704b denotes CH in FEC, 704c denotes CH₂ in PC/EC, 704d denotes CH₂ in DEC/PC, 704e denotes CH₃ in PC, 704f denotes CH₃ in DEC.

FIG. 8 is a plot of ¹⁹F NMR of FEC. 80 denotes f1 (ppm).

FIG. 9 shows ¹⁹F NMR of the electrolytes at different cycles. 900 denotes f1 (ppm). 90a denotes OCV, 90b denotes 3^{rd} cycle, and 90c denotes for 100^{th} cycle. Throughout and in the present disclosure, OCV denotes open circuit voltage.

FIG. 10A relates to electrolyte and structure changes of NFMNO. FIG. 10A shows ¹⁹F NMR of the electrolytes at different cycles (top plot for OCV, center plot for 3^{rd} cycle, bottom plot for 100^{th} cycle). 1000 denotes f1 (ppm).

FIG. 10B relates to electrolyte and structure changes of NFMNO. FIG. 10B shows HAADF-STEM image of the NFMNO at the [001] zone axis. 1001 denotes vertical axis for intensity (a.u.). 1002 denotes horizontal axis for distance (nm).

FIG. 10C relates to electrolyte and structure changes of NFMNO. FIG. 10C shows HAADF-STEM image of the NFMNO at the corresponding layer spacing at edges. 1003 denotes vertical axis for intensity (a.u.). 1004 denotes horizontal axis for distance (nm).

FIG. 10D relates to electrolyte and structure changes of NFMNO. FIG. 10D shows HAADF-STEM image of the NFMNO at the corresponding layer spacing at bulks. 1005 denotes vertical axis for intensity (a.u.). 1006 denotes horizontal axis for distance (nm).

FIG. 11 shows HAADF-STEM image of the NFMNO at the [001] zone axis., and corresponding layer spacing at edges and bulks after 3 cycles. 1100a denotes vertical axis for intensity (a.u.). 1100b denotes horizontal axis for distance (nm).

FIG. 12 shows HAADF-STEM image of the NFMNO at the [001] zone axis., and corresponding layer spacing at edges and bulks after 100 cycles. 1100a denotes vertical axis for intensity (a.u.). 1100b denotes horizontal axis for distance (nm).

FIG. 13A relates to DFT calculations, showing the principles of additive screening.

FIG. 13B relates to DFT calculations, showing comparison of the HOMO energy of different types of sodium salt compounds, solvent molecules, and their exothermic energy with iron in the cathode. 1300a denotes the vertical axis for HOMO level (eV). 1300b denotes the horizontal axis for exothermic energy (kcal/mol).

FIG. 13C relates to DFT calculations, showing comparison of the HOMO energy of NaHMDS, solvent molecules, and their exothermic energy with iron in the cathode. 1300a denotes the vertical axis for HOMO level (eV). 1300b denotes the horizontal axis for exothermic energy (kcal/mol).

FIG. 13D relates to DFT calculations, showing electrostatic potential of NaHMDS and solvent molecules with iron in the NFMNO.

FIG. 14 shows the HOMO energy level diagram. The vertical axis denotes the HOMO level (eV).

FIG. 15 shows the electrostatic potential of different sodium salt compounds binding to iron in the NFMNO.

FIG. 16 is a table of comparison of the HOMO energy of different types of sodium salt compounds, solvent molecules, and their exothermic energy with iron in the NFMNO.

FIG. 17 is a table of comparison of the HOMO energy of NaHMDS, NaTFSI, and their exothermic energy with iron in the NFMNO.

FIG. 18 is a table of comparison of the bond lengths between NaHMDS, NaTFSI, and solvent molecules and the iron in the NFMNO.

FIG. 19A relates to electrochemical performances of NFMNO//Na with NaHMDS additive, showing cycling performance at 0.5 C. The vertical axis denotes capacity (mAh g⁻¹). The horizontal axis denotes cycle number.

FIG. 19B relates to electrochemical performances of NFMNO//Na with NaHMDS additive, showing corresponding Coulombic efficiency. The vertical axis denotes Coulombic efficiency (%). The horizontal axis denotes cycle number.

FIG. 19C relates to electrochemical performances of NFMNO//Na with NaHMDS additive, showing transition metal ion content in the electrolyte after 100 cycles. The vertical axis denotes for the transition metal ion content (mg/L).

FIG. 20A relates to characterizations with NaHDMS additives. FIG. 20A is a plot of the galvanostatic charge-discharge cycling performance. The vertical axis denotes capacity (mAh g⁻¹). The horizontal axis denotes cycle number.

FIG. 20B relates to characterizations with NaHDMS additives. FIG. 20B is a plot of the Coulombic efficiency. The vertical axis denotes Coulombic efficiency (%). The horizontal axis denotes cycle number.

FIG. 20C relates to characterizations with NaHDMS additives. FIG. 20C shows the transition metal ion content in the electrolyte after 100 cycles. The vertical axis denotes for the transition metal ion content (mg/L).

FIG. 20D relates to characterizations with NaHDMS additives. FIG. 20D shows the HAADF-STEM image of the NFMNO at the [001] zone axis, and corresponding layer spacing at edges and bulks. 2000a denotes vertical axis for intensity (a.u.). 2000b denotes horizontal axis for distance (nm).

FIG. 20E shows ¹H NMR at different cycles. Top plot denotes for OCV, center plot denotes for the 3^{rd} cycle, bottom plot denotes for the 100^{th} cycle. 2000e denotes f1 (ppm).

FIG. 21A relates to electrochemical performances of NFMNO//Na with NaHMDS additive. FIG. 21A shows voltage profile vs number of deintercalated ions at 0.2 C for the first cycle (2100a denotes vertical axis for voltage (V vs. Na⁺/Na), 2100b denotes horizontal axis for x in in Na₁₋ₓFe_{1/3}Mn_{1/3}Ni_{1/3}O₂).

FIG. 21B relates to electrochemical performances of NFMNO//Na with NaHMDS additive. FIG. 21B (2102a denotes vertical axis for current (mA), 2102b denotes horizontal axis for voltage (V)) shows CV curves at 0.2 mV s⁻¹. In NFMNO//Na with NaHMDS additive, 0.58 Na⁺ ions are reversibly deintercalated with an initial Coulombic efficiency of 91.1% at 0.2 C. The peaks at 3.45/2.75 V are attributed to the Ni²⁺/Ni³⁺ redox couple, while the peaks around 3.75/3.6 V correspond to the Fe³⁺/Fe⁴⁺ redox reaction. The smaller polarization voltage than that without additives indicates faster reaction kinetics.

FIG. 22A relates to rate performances of NFMNO//Na cells. FIG. 22A shows a plot without additive. In the plot, the vertical axis denotes capacity (mAh g⁻¹), the horizontal axis denotes cycle number.

FIG. 22B relates to rate performances of NFMNO//Na cells. FIG. 22B shows a plot with NaHMDS additive. This NFMNO//Na cell with NaHMDS additive presents enhanced rate performance, delivering capacities of 137.5 mA h g⁻¹ at 0.2 C, 130.0 mA h g⁻¹ at 0.5 C, 118.7 mA h g⁻¹ at 1 C, 103.5 mA h g⁻¹ at 2 C, and 63.4 mA h g⁻¹ at 5 C. In the plot, the vertical axis denotes capacity (mAh g⁻¹), the horizontal axis denotes cycle number.

FIG. 23A relates to long-term cycling performance of an NFMNO//Na cell incorporating NaHMDS as an additive (2300a denotes the left vertical axis for capacity in mAh g⁻¹. 2300b denotes the horizontal axis for cycle number. 2300c denotes the right vertical axis for Coulombic efficiency in %).

FIG. 23B shows the transition metal ion content in the electrolyte after 600 cycles of the cell of FIG. 23A (2301 denotes the vertical axis for transition metal ion content). The NFMNO//Na cell utilizing NaHMDS as an additive demonstrates a capacity retention of 65% and a Coulombic efficiency of 99.8% after 600 cycles at 1 C. Concurrently, the concentration of iron ions in the electrolyte is reduced to 3.42 mg/L.

FIG. 24A to FIG. 24C relate to electrochemical performances of soft pack batteries of NFMNO//Hard carbon. FIG. 24A shows the plot without additive. FIG. 24B shows the plot with NaHMDS additive. FIG. 24C is a picture of soft pack battery. All experimental procedures were consistent except for variations in electrolyte additives. The NFMNO//Na cell utilizing NaHMDS as an additive demonstrates a capacity retention of 65% and a Coulombic efficiency of 99.8% after 600 cycles at 1 C. Concurrently, the concentration of iron ions in the electrolyte is reduced to 3.42 mg/L. In both plots, the left vertical axis denotes capacity (mAh g⁻¹), the horizontal axis denotes cycle number, the right vertical axis denotes Coulombic efficiency (%).

FIG. 25 shows SEM images of NFMNO//Na cells after 100 cycles, without additive (left) and with NaHMDS additive (right).

FIG. 26 shows HAADF-STEM image of the NFMNO at the [001] zone axis, and corresponding layer spacing at edges and bulks with NaHMDS additive after 3 cycles. 2600a denotes the vertical axis for intensity (a.u.). 2600b denotes the horizontal axis for distance (nm).

FIG. 27 shows HAADF-STEM image of the NFMNO at the [001] zone axis, and corresponding layer spacing at edges and bulks with NaHMDS additive after 100 cycles. 2700a denotes the vertical axis for intensity (a.u.). 2700b denotes the horizontal axis for distance (nm).

FIG. 28 shows ¹⁹F NMR of the electrolytes of NFMNO//Na cell with NaHMDS additive at different cycles. In all three plots, the horizontal axis denotes for f1 (ppm). The top plot denotes for OCV, center plot denotes for 3^{rd} cycle, bottom plot denotes for 100^{th} cycle.

FIG. 29 shows ¹H NMR of NaHMDS before (top) and after 100 cycles (bottom). The horizontal axis denotes for f1 (ppm).

FIG. 30A (plot for without NaHMDS additive) and FIG. 30B (plot for with NaHMDS additive) show the normalized XANES spectra of Fe K-edges after 100 cycles with the corresponding metal oxide powders as standard references (in both plots, the vertical axis denotes for normalized χμ in E, the horizontal axis denotes for energy in eV).

FIG. 31A is a HRTEM image showing the interphase properties of NFMNO//Na cells without NaHMDS additives after 3 cycles.

FIG. 31B is a HRTEM image showing the interphase properties of NFMNO//Na cells with NaHMDS additives after 3 cycles.

FIG. 31C shows the EIS spectrum after 3 cycles. The vertical axis denotes for −Z″ (ohm). The horizontal axis denotes for Z′ (ohm).

FIG. 31D is a XPS plot of the F 1s after 3 cycles. The vertical axis denotes for intensity (a.u.). The horizontal axis denotes for binding energy (eV).

FIG. 31E is a XPS plot of the C 1s after 3 cycles. The vertical axis denotes for intensity (a.u.). The horizontal axis denotes for binding energy (eV).

FIG. 31F is a XPS plot of the Fe 2p after 3 cycles. The vertical axis denotes for intensity (a.u.). The horizontal axis denotes for binding energy (eV).

FIG. 32 shows HAADF-STEM image of NFMNO//Na cell with NaHMDS additive after 100 cycles (left image). The right is an HRTEM image of NFMNO//Na cell with NaHMDS additive after 100 cycles.

FIG. 33A and FIG. 33B show EIS spectra of NFMNO//Na cellS with and without NaHMDS additive, wherein FIG. 33A is for after 10 cycles and FIG. 33B is for after 50 cycles. In both plots, the vertical axis denotes for −Z″ (ohm), the horizontal axis denotes for Z′ (ohm).

FIG. 34 shows fitting results for EIS spectra at different cycles.

FIG. 35A and FIG. 35B show the XPS survey spectra of NFMNO//Na cell after 3 cycles, wherein FIG. 35A is for with NaHMDS additive and FIG. 35B is for without NaHMDS additive. In both plots, the vertical axis denotes for intensity (a.u.), the horizontal axis denotes for binding energy (eV).

FIG. 36 shows HAADF-STEM image and the corresponding elemental mappings of NFMNO//Na cell without NaHMDS additive after 3 cycles.

FIG. 37 shows HAADF-STEM image and the corresponding elemental mappings of NFMNO//Na cell with NaHMDS additive after 3 cycles.

FIG. 38 shows the reaction equation for NaHMDS and HF and the corresponding electrostatic potential diagram.

FIG. 39 shows a comparison of the HOMO energy of NaTFSI, solvent molecules, and their exothermic energy with iron in the cathode (left plot, the vertical axis denotes the HOMO level (eV), the horizontal axis denotes the exothermic energy (kcal/mol)). The right image shows electrostatic potential of NaTFSI with iron in the NFMNO.

FIG. 40A to FIG. 40C show the electrochemical performances of NFMNO//Na with NaTFSI additive. FIG. 40A is a plot of the cycling performance at 0.5 C (4100a denotes vertical axis for capacity (mAh g⁻¹), 4100b denotes horizontal axis for cycle number) and FIG. 40B shows the corresponding coulombic efficiency (4101a denotes vertical axis for Coulombic efficiency (%), 4101b denotes cycle number). FIG. 40C shows the transition metal ion content in the electrolyte after 100 cycles (4102a denotes vertical axis for the transition metal ion content (mg/L)).

FIG. 41 shows the long-term cycling performance of an NFMNO//Na cell incorporating NaTFSI as an additive. The left vertical axis denotes capacity (mAh g⁻¹), the horizontal axis denotes cycle number, the right vertical axis denotes Coulombic efficiency (%).

FIG. 42A and FIG. 42B show the electrochemical performances of soft pack batteries of NFMNO//Hard carbon, wherein FIG. 42A is for without additive and FIG. 42B is for with NaTFSI additive. In both plots, the left vertical axis denotes capacity (Ah), the horizontal axis denotes cycle number, the right vertical axis denotes Coulombic efficiency (%).

### DETAILED DESCRIPTION

The following detailed description refers to the accompanying drawings that show, by way of illustration, specific details and embodiments in which the present disclosure may be practiced.

Features that are described in the context of an embodiment may correspondingly be applicable to the same or similar features in the other embodiments. Features that are described in the context of an embodiment may correspondingly be applicable to the other embodiments, even if not explicitly described in these other embodiments. Furthermore, additions and/or combinations and/or alternatives as described for a feature in the context of an embodiment may correspondingly be applicable to the same or similar feature in the other embodiments.

The present disclosure relates to an electrolyte for use in a battery. In various embodiments, the battery may be a sodium-ion battery.

The electrolyte, which may also be referred to herein as an electrolyte composition, provides significant improvements in the electrochemical performance and durability of alkali-metal batteries, particularly sodium-ion batteries employing layered transition-metal oxide cathodes. By incorporating a nitrogen-containing Lewis base additive into a traditional carbonate-based electrolyte, the electrolyte effectively mitigates capacity fading mechanisms associated with high-voltage cycling. In particular, the additive can exhibit a higher electron-donating capability than the carbonate solvents, thereby undergoing oxidation or coordination reactions before solvent decomposition occurs. This can help suppress parasitic oxidative reactions of the electrolyte solvents at elevated potentials and contributes to improved Coulombic efficiency and cycle stability.

A further technical advantage arises from the ability of the nitrogen-containing Lewis base additive to coordinate with transition-metal ions, especially iron ions, present in layered sodium oxide cathode materials. Such coordination stabilizes high-valent metal species formed during charging and inhibits transition-metal dissolution into the electrolyte. As a result, the concentration of dissolved metal ions is significantly reduced, which in turn limits electrolyte contamination, impedance growth, and degradation of the electrode-electrolyte interface. This effect contributes to enhanced capacity retention over extended cycling and improved long-term battery reliability.

Additionally, the presence of the disclosed additive promotes the formation of a more stable and uniform cathode-electrolyte interphase (CEI). The additive participates in controlled interfacial reactions that yield an inorganic-rich and chemically robust surface layer, which protects the cathode from continuous electrolyte attack while maintaining efficient ion transport. This stabilized interface reduces charge-transfer resistance, improves rate capability, and supports high-voltage operation without compromising structural integrity of the cathode material.

Collectively, these technical effects enable the electrolyte and battery to achieve higher Coulombic efficiency, reduced capacity fading, suppressed solvent decomposition, and improved interfacial stability, while remaining compatible with commercially relevant carbonate solvents and electrode materials. The electrolyte therefore provides a practical and scalable solution for enhancing the performance and service life of sodium-ion batteries and related electrochemical energy-storage systems.

Understandably, it follows that a battery containing such electrolyte, and the methods for forming such electrolyte and such battery, have the same advantages of the electrolyte.

Details of various embodiments of the present electrolyte, a method for forming the electrolyte, a battery comprising the electrolyte, and a method for forming the battery, and advantages associated with the various embodiments are now described below. Where the embodiments and advantages are described in the examples section further hereinbelow, they shall not be iterated for brevity.

The present disclosure describes an electrolyte for use in a battery. The battery may be a sodium-ion battery. The battery may comprise an electrolyte salt, a solvent, and a nitrogen-containing Lewis base additive (referred to as “additive” for brevity) having a stronger electron-donating ability than the solvent. The electrolyte, with such components, including the additive, synergistically, provides preferential electron donation relative to carbonate solvents, thereby suppressing solvent oxidation at high operating voltages. This in turn renders improved Coulombic efficiency, reduced electrolyte decomposition, and enhanced long-term cycle stability.

In various embodiments, the nitrogen-containing Lewis base additive may comprise an amino sodium salt, an imine sodium salt, or a cyclic nitrogen-containing sodium salt, or a derivative thereof. Advantageously, additive of the present disclosure, such as the additives disclosed herein, may comprise a Lewis basic nitrogen center that can coordinate with high-valent transition metal ions generated during charging, particularly Fe⁴⁺ species in layered NaFe₁/₃Mn₁/₃Ni₁/₃O₂ cathodes. Such coordination stabilizes reactive metal centers and significantly reduces transition-metal dissolution into the electrolyte. This lowers metal contamination of the electrolyte and mitigates impedance growth during cycling. Said differently, in layered oxides containing iron, the additive can specifically address the dominant capacity-fading mechanism (iron dissolution and solvent oxidation), providing targeted stabilization of Fe-containing layered cathodes while maintaining structural integrity and interlayer spacing during cycling.

In various embodiments, the nitrogen-containing Lewis base additive may comprise sodium bis(trifluoromethanesulfonyl)amide (abbreviated as NaTFSI, molecular formula: C₂F₆NNaO₄S₂), sodium difluorosulfonylamide (abbreviated as NaDFSA, molecular formula: F₂NNaO₄S₂), sodium bis(trimethylsilyl)amide (abbreviated as NaHMDS, molecular formula: C₆H₁₈NNaSi₂), sodium 1,2,4-triazolide (molecular formula: C₂H₃N₃Na), sodium saccharinate (molecular formula: C₁₉H₁₇N₂NaO₄S), or a mixture thereof.

In various embodiments, the electrolyte salt may comprise sodium hexafluorophosphate, sodium perchlorate, sodium bis(trifluoromethanesulfonyl)imide, sodium bis(fluorosulfonyl)imide, sodium trifluoromethanesulfonate, or a mixture thereof. These salts can exhibit elevated HOMO energy levels relative to carbonate solvents and demonstrate strong binding affinity toward transition metal ions. This dual kinetic-thermodynamic factor helps in effective protection of the cathode while maintaining compatibility with conventional carbonate-based electrolytes. As one non-limiting example, NaHMDS provides particularly strong Fe-N coordination and high electron-donating capability, rendering substantially reduced iron ion concentration in the electrolyte, improved Coulombic efficiency approaching 100%, enhanced capacity retention under extended cycling, and formation of a stable and uniform cathode-electrolyte interphase (CEI). Additionally, NaHMDS can react with trace HF to form stable sodium fluoride species, further protecting the cathode surface and suppressing acid-induced metal dissolution. The other electrolyte salts mentioned have these advantages.

In various embodiments, the solvent may comprise an organic solvent. In various embodiments, the solvent may be absent of an aqueous solvent. In various embodiments, the solvent may comprise an organic carbonate-based solvent. In various embodiments, the organic carbonate-base solvent may comprise ethylene carbonate (EC), dimethyl carbonate (DMC), diethyl carbonate (DEC), propylene carbonate (PC), fluoroethylene carbonate (FEC), ethyl methyl carbonate (EMC), or a mixture thereof. The additives of the present disclosure, including the other components of the electrolyte, are fully compatible with commercially available carbonate solvent systems. As one non-limiting example, the additive suppresses oxidative decomposition of susceptible solvents, such as DEC, during high-voltage charging, thereby preserving electrolyte integrity without requiring reformulation of established solvent systems.

In various embodiments, the nitrogen-containing Lewis base additive may be present in an amount of 0.5 wt % to 5 wt %, 1 wt % to 5 wt %, 2 wt % to 5 wt %, 3 wt % to 5 wt %, 4 wt % to 5 wt %, 0.5 wt % to 1 wt %, 0.5 wt % to 2 wt %, 0.5 wt % to 3 wt %, 0.5 wt % to 4 wt %, etc., based on a total weight of the electrolyte. At amounts below 0.5 wt %, there may be a risk where the additive may be insufficient to effectively coordinate high-valent Fe⁴⁺ species, suppress transition-metal dissolution, or outcompete solvent oxidation, and surface coverage of the cathode-electrolyte interphase (CEI) may be incomplete as well as the protective interphase may not form uniformly. At amounts more than 5 wt %, there may be a risk where the electrolyte viscosity may undesirably increase, ionic conductivity may undesirably decrease, Na⁺ transport number may be adversely affected. Moreover, excess additive may participate in parasitic side reactions, over-thicken the CEI, undesirably increase interfacial resistance.

The present disclosure also relates a method for forming the electrolyte described in various embodiments of the first aspect. Embodiments and advantages described for the present electrolyte can be analogously valid for the present method subsequently described herein, and vice versa. Where the various embodiments and advantages have already been described above and in the examples section further hereinbelow, they shall not be iterated for brevity.

In various embodiments, the method may comprise mixing the electrolyte salt and the nitrogen-containing Lewis base additive in the solvent. Advantageously, with the present method, the additive can be uniformly distributed throughout the electrolyte. This helps with consistent availability of the additive at, for example, the cathode surface, the bulk electrolyte, and interfacial regions, of a battery comprising such electrolyte, i.e., uniform metal-ion coordination and consistent suppression of solvent oxidation across the entire electrode surface. Moreover, when the additive is present in solution prior to cell assembly, it can rapidly coordinate with dissolved or surface-exposed transition-metal ions, and interact with high-valent Fe species during the first charge cycle, i.e., Early-stage stabilization of the cathode and reduction of initial capacity loss. In other words, such a preparation method ensures homogeneous distribution of the additive, enabling uniform coordination with transition-metal ions and controlled formation of a stable cathode-electrolyte interphase. The method further allows immediate stabilization of high-valent metal species during initial charging cycles and is compatible with conventional electrolyte manufacturing processes, thereby facilitating scalable production without modification of electrode materials.

In various embodiments, the solvent may comprise an organic carbonate-based solvent. Advantage(s) of this feature has been described in one or more embodiments mentioned above.

In various embodiments, the organic carbonate-based solvent may comprise ethylene carbonate, diethyl carbonate, and propylene carbonate, mixed in a ratio of 1 to 5:1 to 10:1 to 5. In one non-limiting example, the ratio may be 1:1:1. Advantageously, these ratios may provides a balanced electrolyte system in which, for example, EC and PC contribute high dielectric constant and strong salt-dissolving capability to ensure stable Na⁺ solvation and interphase formation, while the higher proportion of DEC reduces viscosity and enhances ionic mobility and rate performance. The defined range balances the trade-off between ionic conductivity, electrochemical stability, and interfacial protection, thereby supporting high-voltage operation while maintaining favorable transport properties and long-term cycling stability. Ratios outside this range may run the risk of insufficient salt solubility, excessive viscosity, reduced conductivity, or increased solvent decomposition, leading to diminished battery performance.

The present disclosure also relates a battery comprising the electrolyte described in various embodiments of the first aspect. Embodiments and advantages described for the present electrolyte and its method of forming can be analogously valid for the battery subsequently described herein, and vice versa. Where the various embodiments and advantages have already been described above and in the examples section further hereinbelow, they shall not be iterated for brevity.

In various embodiments, the battery may comprise an anode, a cathode that may comprise sodium and a transition metal oxide, wherein the transition metal oxide may comprise iron, and an electrolyte described in various embodiments of the first aspect. The electrolyte can reduce parasitic reactions and metal crossover to the anode, improving interfacial stability at both electrodes. This contributes to improved rate capability, reduced resistance growth, and enhanced overall battery lifespan.

In various embodiments, the transition metal oxide may further comprise manganese, nickel, copper, or titanium. The transition metals can enable tuning of the electrochemical redox activity, structural stability, and electronic conductivity of the cathode material. For example, nickel may enhance reversible capacity through additional redox contribution, manganese may improve structural robustness and mitigate Jahn-Teller distortion, copper may facilitate electronic conductivity, and titanium may enhance structural integrity and cycling stability. The presence of these metals also allows modulation of the oxidation potential and stabilization of the layered framework during repeated sodium intercalation and deintercalation. As a result, the cathode can achieve improved capacity retention, rate capability, and long-term durability, while remaining compatible with the disclosed nitrogen-containing Lewis base additive system.

In various embodiments, the cathode may comprise NaFe_{1/3}Mn_{1/3}Ni_{1/3}O₂, NaCuFeMnO₂, or NaFeMnNiO₂. The layered sodium transition-metal oxides of the present disclosure can provide multiple redox-active centers while maintaining a structurally stable O3-type layered framework capable of reversible sodium intercalation and deintercalation. The presence of iron enables high-voltage redox activity, while manganese, nickel, or copper contribute to capacity, structural stability, and electronic conductivity. Such multi-component compositions allow tuning of electrochemical potential and capacity while maintaining mechanical integrity during cycling. In combination with the disclosed nitrogen-containing Lewis base electrolyte additive, these cathode materials benefit from reduced transition-metal dissolution and suppressed solvent oxidation, resulting in improved capacity retention, enhanced Coulombic efficiency, and prolonged cycle life under high-voltage operating conditions.

In various embodiments, the anode may comprise carbon (e.g., hard carbon), sodium (e.g., sodium metal), copper, or aluminum (e.g., a current collector substrate such as a copper and/or aluminum foil). Particularly, the inclusion of hard carbon enables stable and reversible sodium-ion storage with good rate capability and structural tolerance to repeated sodiation and desodiation, while sodium metal provides high theoretical capacity and energy density for high-performance embodiments. The use of copper and/or aluminum foils as current collectors ensures efficient electronic conductivity, mechanical support, and compatibility with traditional cell manufacturing processes. This flexibility in anode selection allows the battery system to be tailored for either high energy density or enhanced safety and cycling stability, while remaining fully compatible with the disclosed electrolyte and additive system, thereby supporting scalable and versatile battery configurations.

The present disclosure also relates a method for forming the battery described in various embodiments mentioned above. Embodiments and advantages described for the present electrolyte, its method of forming, and the battery can be analogously valid for the present method subsequently described herein, and vice versa. Where the various embodiments and advantages have already been described above and in the examples section further hereinbelow, they shall not be iterated for brevity.

In various embodiments, the method may comprise forming the anode, forming the cathode, forming the electrolyte described in various embodiments of the first aspect, and assembling the anode, the cathode, and the electrolyte configured between the anode and the cathode, to form the battery.

In various embodiments, forming the cathode may comprise mixing a cathode active material with a conductive agent (e.g., Super P and/or acetylene black) and a binder in a cathode solvent to form a slurry, coating the slurry on a current collector, and drying the slurry coated on the current collector. This method includes the nitrogen-containing Lewis base additive for incorporation within the electrolyte at the time of cell assembly, thereby enabling immediate stabilization of the electrode-electrolyte interfaces during initial charging cycles. The method is compatible with traditional electrode fabrication and battery assembly processes, requiring no additional coating or post-treatment steps, which simplifies manufacturing and facilitates industrial scalability. By incorporating the electrolyte directly during assembly, the resultant battery exhibits improved interfacial stability, reduced transition-metal dissolution, and enhanced cycling performance without modification of established production workflows.

In various embodiments, the cathode active material may comprise a powder comprising NaFe_{1/3}Mn_{1/3}Ni_{1/3}O₂, NaCuFeMnO₂, or NaFeMnNiO₂. Advantages of these have been described in one or more embodiments above.

In various embodiments, the mixing the cathode active material with the conductive agent and the binder may comprises mixing the cathode active material in an amount more than the conductive agent and/or the binder, and/or mixing the conductive agent and the binder in an equal amount. This part of the method enables uniform dispersion of the active material and conductive agents, forming a continuous electronic percolation network that enhances electrical conductivity and reduces internal resistance. The binder promotes strong adhesion between the active material and the current collector, improving mechanical integrity and mitigating particle detachment during repeated charge-discharge cycles. The coating and drying process further ensures controlled electrode thickness and porosity, facilitating efficient electrolyte infiltration and sodium-ion transport. The cathode can then exhibit improved electrochemical utilization, stable interfacial contact, and enhanced long-term cycling performance while remaining compatible with scalable industrial electrode manufacturing processes.

In various embodiments, drying the slurry coated on the current collector may comprise subjecting the slurry to vacuum at a temperature range of 60 °C to 120 °C, 80 °C to 120 °C, 100 °C to 120 °C, 60 °C to 80 °C, 60 °C to 100 °C, etc., for 6 hours to 24 hours, 10 hours to 24 hours, 15 hours to 24 hours, 20 hours to 24 hours, etc.

In the present disclosure, the term “room temperature” may be a range from 20 °C to 30 °C. Such controlled thermal-vacuum treatment facilitates effective removal of residual solvent and moisture, reducing trace water content that may otherwise undesirably promote electrolyte salt hydrolysis and formation of acidic species during battery operation. The selected temperature and time ranges are sufficient to achieve thorough drying without inducing thermal degradation of the binder, conductive additives, or active material structure. Vacuum drying further enhances pore uniformity and interparticle contact within the electrode, resulting in improved mechanical stability, reduced interfacial resistance, and more stable long-term cycling performance. Consequently, the drying parameters contribute to enhanced electrochemical stability and reproducibility of the assembled battery.

In the context of various embodiments, the tilde symbol “~”, the term “about”, and the term “approximately”, as applied to a numeric value encompasses the exact value and a reasonable variance. The variance may be ±20%, ±10%, ±5%, ±1%, ±0.5%, ±0.1%, etc.

The word “substantially” does not exclude “completely” e.g. a composition which is “substantially free” from Y may be completely free from Y. Where necessary, the word “substantially” may be omitted from the definition of the present disclosure.

In the context of various embodiments, the articles “a”, “an” and “the” as used with regard to a feature or element include a reference to one or more of the features or elements.

In the context of various embodiments, the term “about” or “approximately” as applied to a numeric value encompasses the exact value and a reasonable variance.

As used herein, the term “and/or” includes any and all combinations of one or more of the associated listed items.

As used herein, the term “hour” and “hours” may be denoted interchangeably using “h”, “hr”, and “hrs”.

Unless specified otherwise, the terms “comprising” and “comprise”, and grammatical variants thereof, are intended to represent “open” or “inclusive” language such that they include recited elements but also permit inclusion of additional, unrecited elements.

### EXAMPLES

The mechanisms underlying capacity fading during cycling in layered oxide cathode materials for sodium-ion batteries, generally, remain inadequately understood. Elucidating the reasons and effective strategies may help to address such a limitation. Traditionally, in NaFe_{1/3}Mn_{1/3}Ni_{1/3}O₂, the cause of capacity fading may be iron ions dissolution. Additionally, the extraction of sodium ions (after the Fe³⁺/Fe⁴⁺ reaction) lowers the energy level of NaFe₁/₃Mn₁/₃Ni₁/₃O₂ below that of the electrolyte solvent, thereby inducing solvent decomposition. Here, the various examples establish screening criteria for electrolyte additives through theoretical calculations to improve capacity retention. We identified a series of nitrogen-containing Lewis base additives that can kinetically bind efficiently to iron ions in NaFe_{1/3}Mn_{1/3}Ni_{1/3}O₂ and thermodynamically exhibit stronger electron-donating abilities than the solvents. Here, a compound sodium bis(trimethylsilyl)amide (which is not tradtionally studied as a Na-ion battery additive) is selected through the Reaxys database (out of 61 molecules) because it is economical and is relatively stable in the electrochemical process as one of the examples. Such additive is demonstrated as one of the examples to greatly improve the Coulombic efficiency and reduce the dissolution of iron ions of NaFe_{1/3}Mn_{1/3}Ni_{1/3}O₂//hard carbon cells.

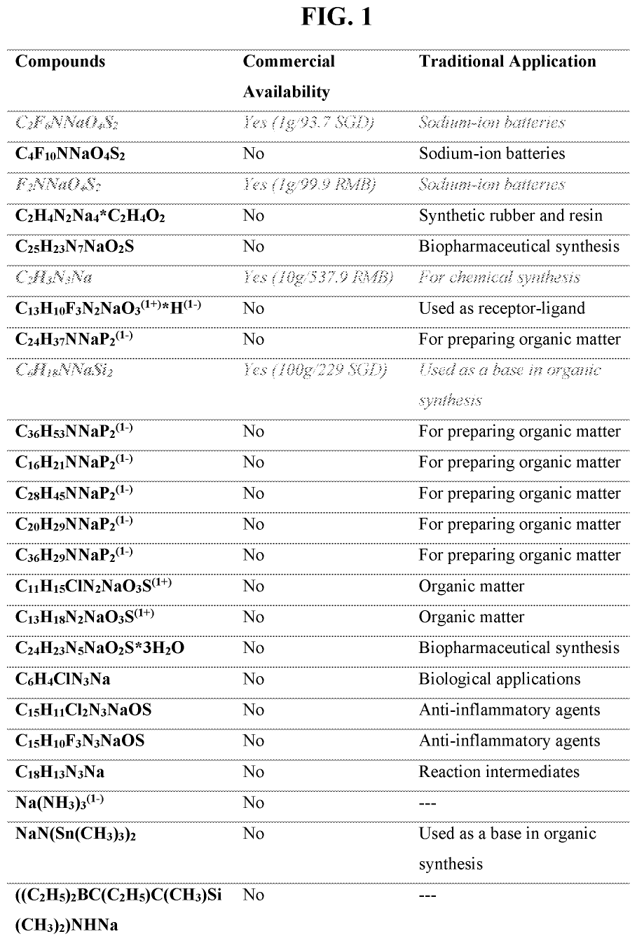

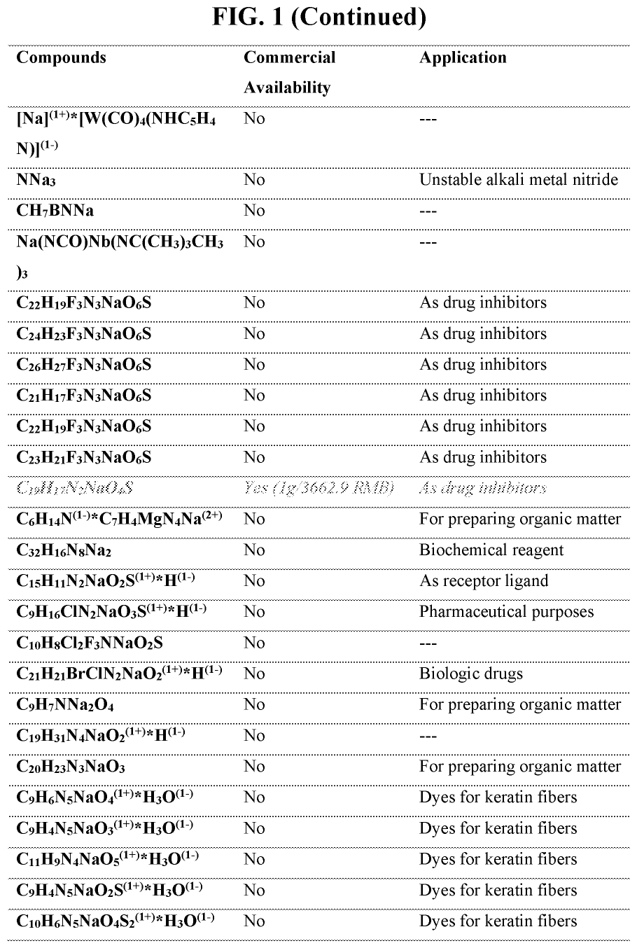

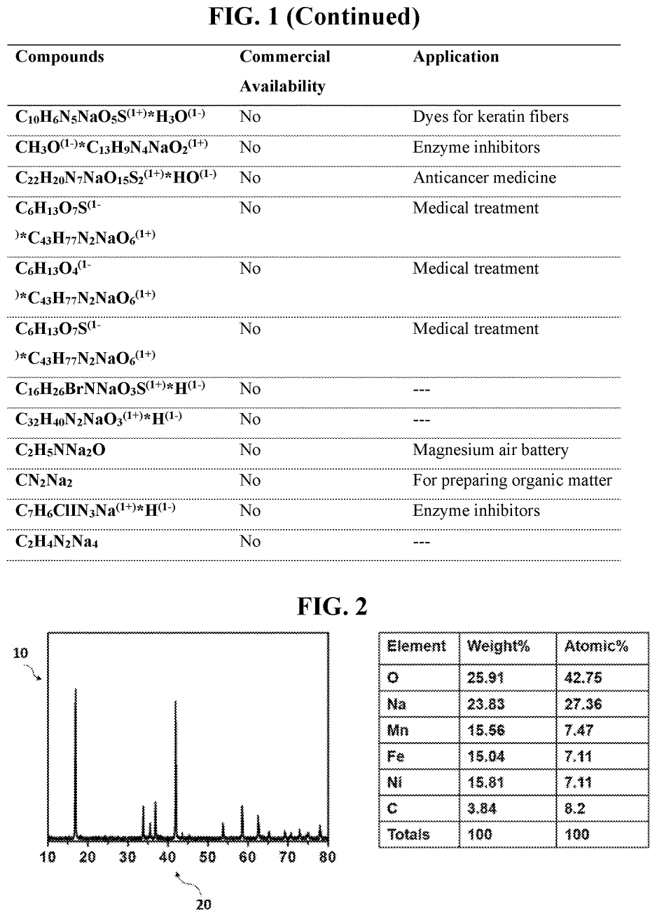

In various examples, first, a comprehensive analysis of the capacity degradation mechanisms in the layered oxide NaFe_{1/3}Mn_{1/3}Ni_{1/3}O₂ (NFMNO) sodium-ion battery cathode material was conducted and criteria for the systematic screening of electrolyte additives to improve their capacity retention was established. Through X-ray absorption spectroscopy (XAS) and inductively coupled plasma atomic emission spectrometry (ICP-AES) analyses, it was found that capacity degradation is predominantly attributed to the dissolution of iron ions, rather than nickel or manganese ions. This dissolution is primarily driven by the effects of unstable high-valent iron ions and hydrogen fluoride (HF). Simultaneously, the orbital energy variations in NFMNO during charging result in the decomposition of the solvent, particularly diethyl carbonate (DEC). This process has been confirmed through nuclear magnetic resonance (NMR), high-resolution transmission electron microscopy (HRTEM), and X-ray photoelectron spectroscopy (XPS) analyses. Then, through density functional theory (DFT) calculations and simulations, a series of nitrogen-containing Lewis base electrolyte additives were identified. These additives kinetically demonstrate a strong affinity for binding with iron ions of NFMNO and thermodynamically possess stronger electron-donating capabilities than solvent molecules. 61 compounds were screened from the Reaxys database (FIG. 1), among which the compound sodium bis(trimethylsilyl)amide (NaHMDS, traditionally not used as a sodium-ion battery additive before) is selected as one of the examples because it is commercially available, inexpensive, and relatively stable in electrochemical processes. It has been demonstrated to improve Coulombic efficiency and reduce iron ion content in electrolytes. This approach and screening criteria can be extended to provide insights for analyzing capacity fading in other battery systems.

The present electrolyte and battery, and their methods of forming, are described in further details, by way of non-limiting examples, as set forth below.

### Example 1: Experimental Section

The NaFe_{1/3}Mn_{1/3}Ni_{1/3}O₂ (NFMNO) cathode material was purchased from Jiangsu Xiangying Amperex Technology Limited and used without further treatment.

### Electrochemical Measurement.

The cathode was prepared by mixing NaFe_{1/3}Mn_{1/3}Ni_{1/3}O₂ (NFMNO) powder, super P, and polyvinylidene fluoride in a weight ratio of 8:1:1, using 1-methyl-2-pyrrolidone as the solvent. The resulting slurry was subjected to half an hour of mixing with a vacuum planetary centrifugal mixer, then coated onto the aluminum (Al) current collector, and vacuum dried at 80 °C for 12 h. Following this, the electrode was rolled and cut into disks with a diameter of 12 mm. Sodium metal was employed as the counter electrode, and glass fiber (Whatman GF/F) was used as the separator. The active mass loading of the cathode electrode was 3-5 mg cm⁻². CR2032-type coin cells were assembled in an argon-filled glove box (MIKROUNA, H₂O<1 ppm; O₂<1 ppm). The electrolyte comprised 1 M NaPF₆ in a solvent mixture of ethylene carbonate (EC), diethyl carbonate (DEC), and propylene carbonate (PC) in a 1:1:1 ratio, supplemented with 5 vol % fluoroethylene carbonate (FEC), with 0.05 M sodium bis(trimethylsilyl)amide (NaHMDS) or sodium bis(trifluoromethylsulfonyl)imide (NaTFSI) employed as additives. The 4 Ah pouch cells were purchased without electrolyte from Jiangsu Xiangying Amperex Technology Limited, with NFMNO as the cathode and hard carbon as the anode. The electrolyte was injected in a glove box, with an injection amount of 6 g/Ah. Galvanostatic discharge/charge testing was conducted at 25 °C within a voltage range of 2-4 V using a Neware battery tester (China). Cyclic voltammetry (CV) curves and Electrochemical impedance spectroscopy (EIS) measurements (ranging from 100 kHz to 0.01 Hz) were performed at room temperature using an electrochemical workstation (CHI760E, China).

### Characterization.

Powder X-ray diffraction (XRD) patterns were recorded using an X-ray diffractometer (Bruker D8 Advanced, Germany) with monochromatic Cu Kα radiation. Scanning electron microscopy (SEM) images, energy-dispersive X-ray spectroscopy (EDX) data, and elemental mapping were obtained using a field-emission scanning electron microscope (JEOL JSM-7600F, Japan). The high-resolution transmission electron microscopy (HRTEM) images and elemental mappings were conducted in a transmission electron microscope (Talos F200i, USA). High-angle annular dark field-scanning transmission electron microscopy (HAADF-STEM) images were acquired using an aberration-corrected transmission electron microscope (JEM-ARM300F2, Japan) operating at 300 kV. X-ray photoelectron spectroscopy (XPS) spectra were collected using an X-ray photoelectron spectrometer (Thermo Scientific ESCALAB 250, USA). Inductively coupled plasma atomic emission spectrometry (ICP-AES) was performed with an emission spectrometer (PE-8000, USA). Nuclear magnetic resonance (NMR) spectra were recorded with an advanced spectrometer (JEOL ECA400, Japan), using DMSO-d6 as the solvent for ¹H and ¹⁹F spectroscopy. The acquired X-ray absorption spectroscopy (XAS) spectra were conducted in transmission mode at beamline BL14b2 in Japan, with data analysis including energy calibration and normalization performed using the ATHENA software package. All cell disassembly for ex-situ testing was performed in a glove box and transferred under an Ar atmosphere. All cell disassembly for ex-situ testing was conducted in a glove box and subsequently transferred under an argon atmosphere.

### Density Functional Theory (DFT) Calculation.

All DFT calculations in this study were conducted utilizing the Gaussian 16 software package. Geometry optimizations of stationary points were performed using the M06 hybrid functional, employing the LANL2DZ effective core potential (ECP) with a double-ξ valence basis set, supplemented by a polarization function for Fe (ξf=2.462), Ni (ξf=3.130), and Fe (ξf=2.195) atoms, respectively. For all other atoms, the 6-311+G(d,p) basis set^{[6]} was utilized. Frequency analyses were conducted at the same level of theory to verify that the optimized structures correspond to local minima (characterized by the absence of imaginary frequencies) and to calculate the Gibbs free energy. The changes in Gibbs free energy were calculated using the following equation:

ΔG^{r}=G(pro)−G¹(react)−G²(react)

where the ΔG^{r}, G(pro), G¹(react) and G²(react) represent the Gibbs free energies of reaction energy, product, reactant 1 and reactant 2, respectively.

### Example 2: Investigation of Electrochemical Properties and Capacity Degradation Mechanisms of NFMNO

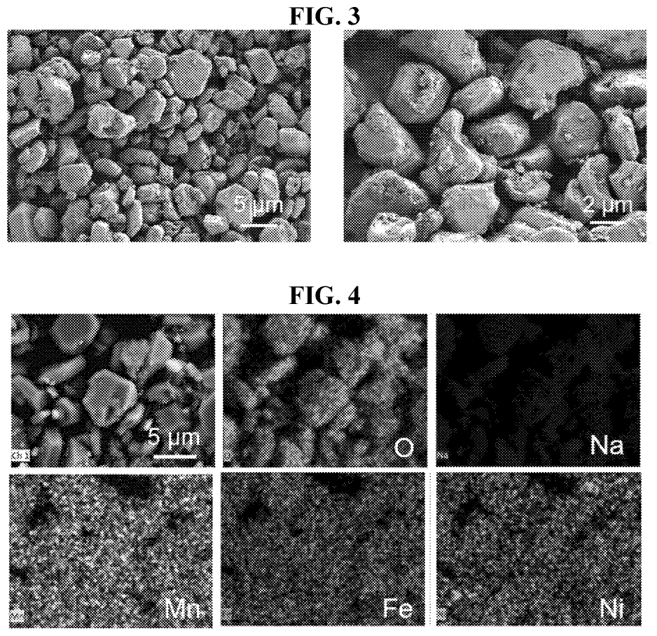

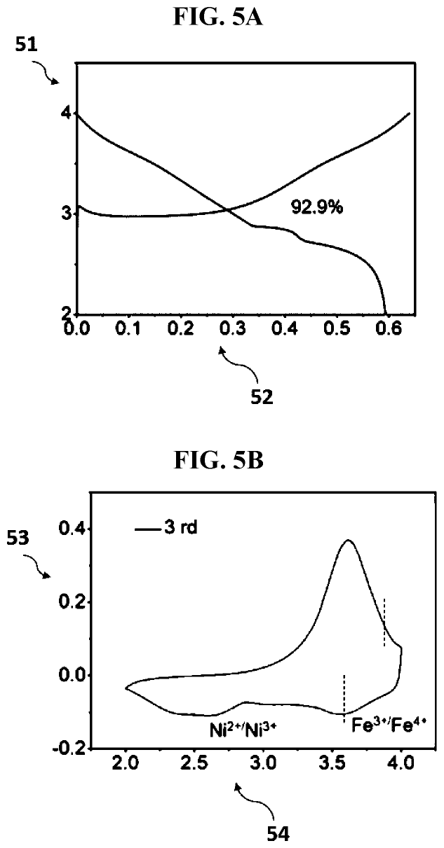

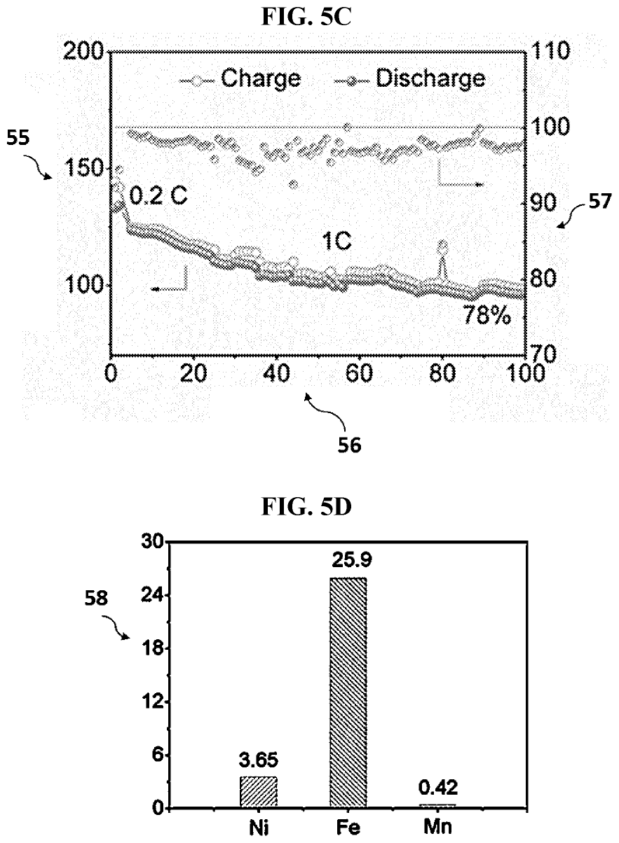

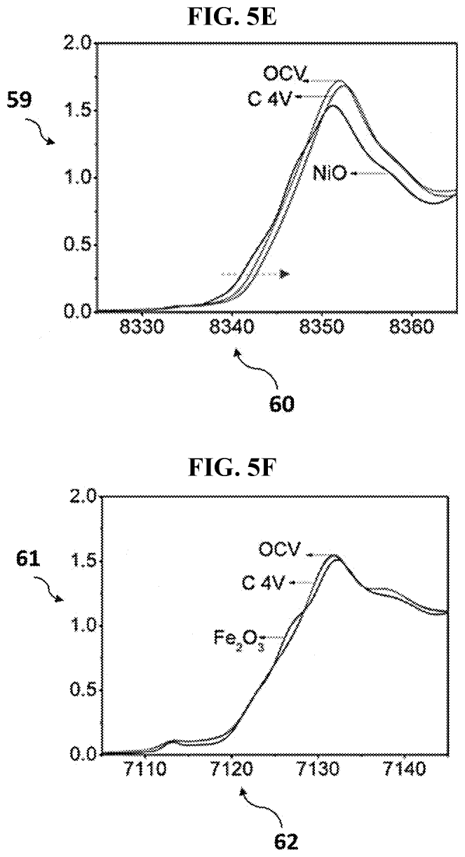

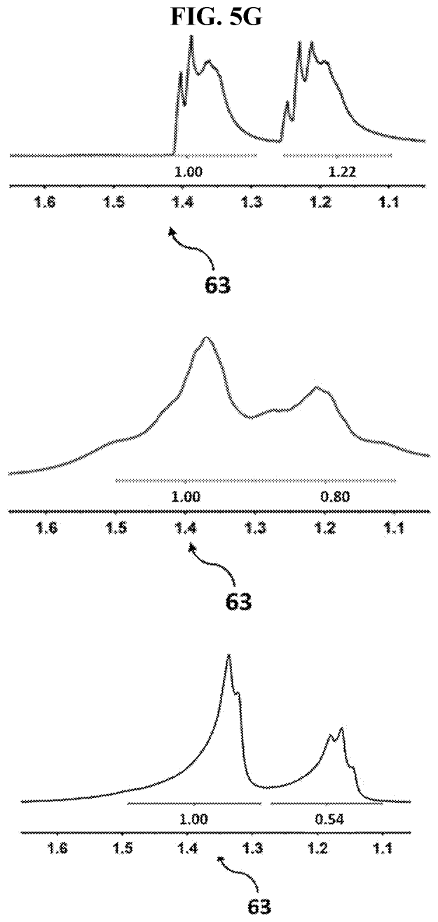

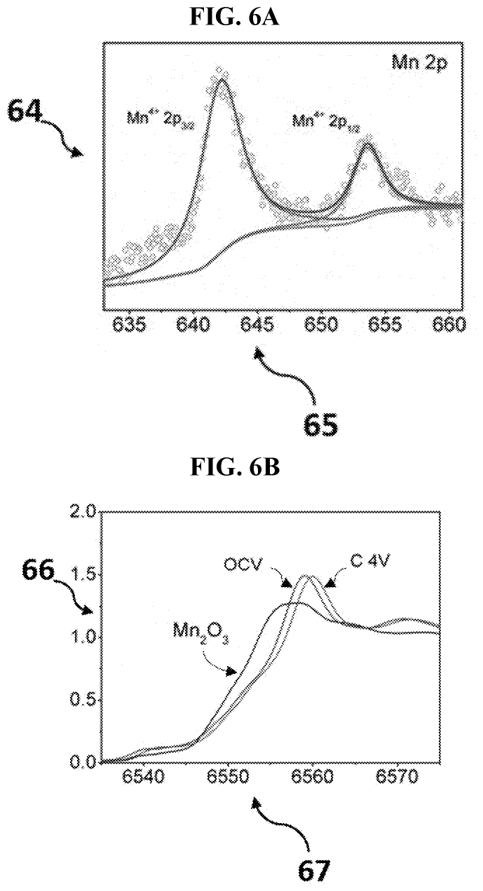

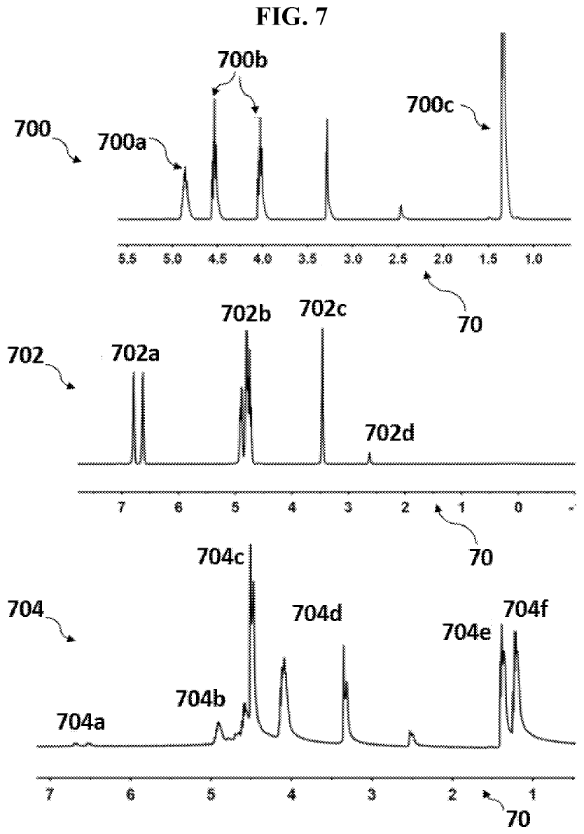

The commercially obtained NFMNO cathode exhibits a hexagonal crystal structure (space group: R-3m, No. 166), which results from substituting 2/3 of the Fe in NaFeO₂ with 1/3 Mn and 1/3 Ni elements (FIG. 2). The particles exhibit a size range of 2-5 μm, featuring a homogeneous distribution of elements (FIG. 3 and FIG. 4). As a promising cathode material for sodium batteries, its degradation in ambient air has been extensively studied. However, further investigation into its capacity failure mechanisms during the electrochemical reaction process is particularly crucial. NFMNO//Na cells are tested within a voltage range of 2-4 V using an electrolyte composed of 1 M NaPF₆ in a solvent mixture of ethylene carbonate (EC), diethyl carbonate (DEC), and propylene carbonate (PC) in a 1:1:1 ratio, supplemented with 5 vol % fluoroethylene carbonate (FEC). In NFMNO, 0.59 Na⁺ ion per unit cell are reversibly intercalated/de-intercalated with an initial Coulombic efficiency of 92.9% at 0.2 C (FIG. 5A). The contribution of each transition metal's redox reaction to capacity is verified through cyclic voltammetry (CV) testing. The peaks at 3.5/2.5 V are attributed to the Ni²⁺/Ni³⁺ redox couple, while the peaks around 3.8/3.6 V correspond to the Fe³⁺/Fe⁴⁺ redox reaction (FIG. 5B). This indicates that Mn hardly participates in the electrochemical reactions within this voltage range. The NFMNO//Na cell displays a discharge capacity of 96.6 mAh g⁻¹ after 100 cycles at 1 C, demonstrating noticeable capacity degradation. After 100 cycles, the capacity retention is 78% with a Coulombic efficiency of 98% (FIG. 5C). The underlying causes of capacity fading were investigated using ICP-AES, XAS, and NMR characterizations. The composition of the electrolyte after 100 cycles was analyzed, revealing an iron ion concentration of 25.9 mg/L, a nickel ion concentration of 3.65 mg/L, and an almost negligible presence of manganese ions (FIG. 5D). This indicates that the dissolution of iron ions is dominant. The K-edge spectra for Ni, Fe, and Mn in various states were acquired. Mn's valence state remains essentially unchanged (FIG. 6A and FIG. 6B), whereas the valence state of Ni increased when charged to 4 V (FIG. 5E), consistent with the CV curves. In contrast to the expected increase in valence state, Fe did not exhibit change (FIG. 5F). This suggests that the formed Fe⁴⁺ is unstable and can readily capture electrons from the solvent, leading to the oxidation of the electrolyte. NMR spectroscopy was employed to analyze the electrolyte after different cycles to assess any alterations in its composition. Due to the overlap of solvent peaks, we specifically selected non-overlapping peaks for integration and quantification analysis to ensure accurate results (FIG. 7). The peak at 1.36 ppm is attributed to the methyl group (CH₃) of PC, while the peak at 1.2 ppm corresponds to the CH₃ of DEC. With an increasing number of cycles, the concentration of DEC gradually diminishes (FIG. 5G). During the charging process, the release of Na⁺ions results in the Fermi level of the NFMNO material falling below the Highest Occupied Molecular Orbital (HOMO) energy of DEC (after Fe3+/Fe³⁺ redox reaction), inducing its oxidative ecomposition. The dissolution of transition metal ions (Fe³⁺) and the decomposition of the solvent (DEC) may jointly lead to low Coulombic efficiency.

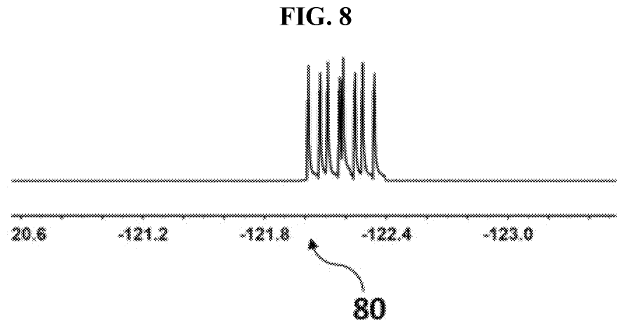

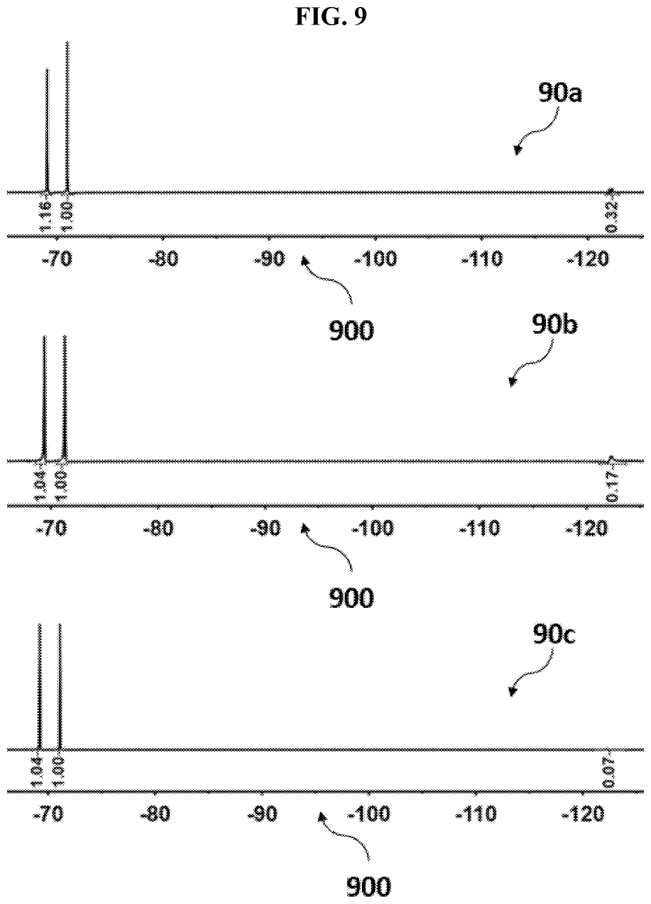

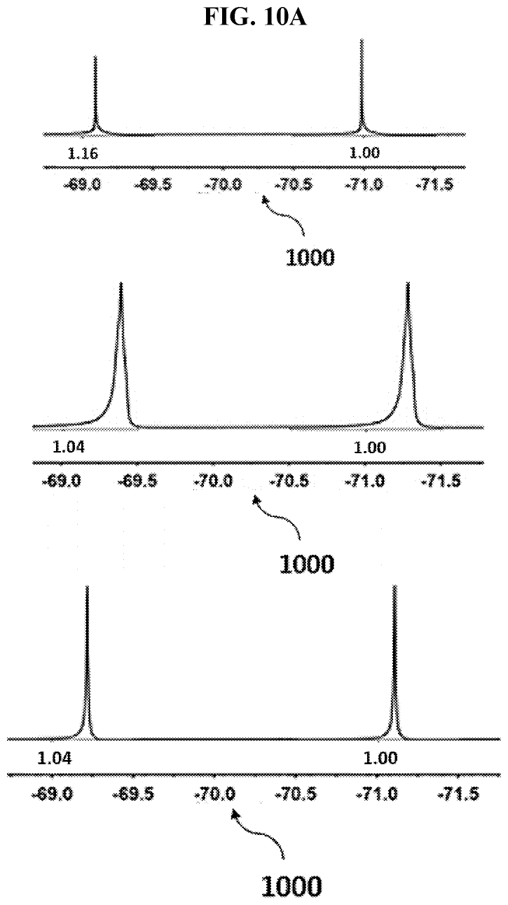

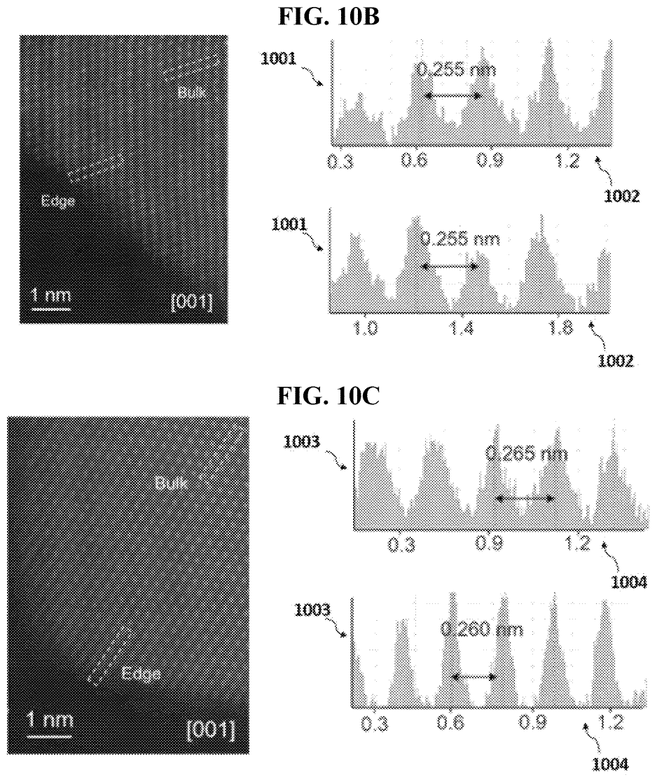

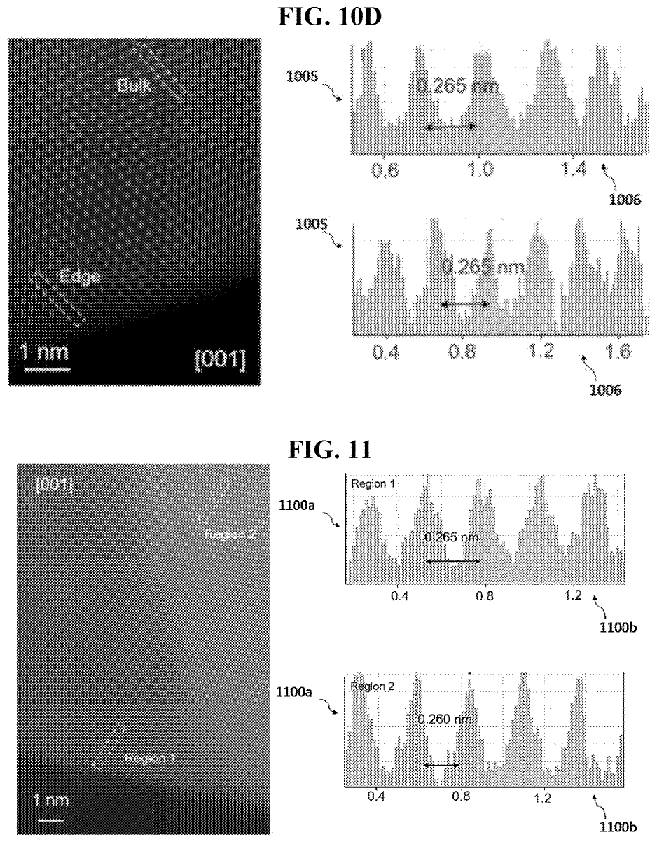

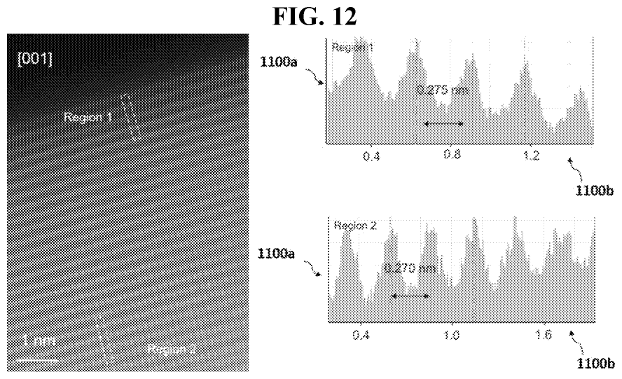

In addition, whether the dissolution of iron ions is attributable to side reactions of electrolytes or structural distortion during the material intercalation/deintercalation process was investigated. This directly influences whether the strategy should focus on the design of the material structure itself or the development of electrolyte components. ¹⁹F NMR spectroscopy was conducted on the electrolyte after various cycles. The multiple peaks around 122 ppm are attributed to FEC (FIG. 8). The ¹⁹F NMR spectrum indicates that FEC progressively diminishes throughout the cycling process and contributes to forming the solid electrolyte interphase film (FIG. 9). The peak at −69.6 ppm corresponds to the molecular form of NaPF₆, whereas the peak at 71.1 ppm represents the clustered form of NaPF₆ in the electrolyte. At a concentration of 1 M, the molecular form dominates over the clustered form. After 3 cycles, the molecular form of NaPF₆ begins to decompose; however, its content stabilizes and does not change after 100 cycles (FIG. 10A). This suggests that the hydrolysis of NaPF₆ leads to the formation of HF³⁵ with the reaction continuing until all the available water is consume. While it is impossible to eliminate water completely, its presence must be tightly controlled to mitigate side reactions during battery manufacturing. The atomic phase and structure of NFMNO in different states were characterized using aberration-corrected scanning transmission electron microscopy (STEM) with high-angle annular dark-field (HAADF) techniques (FIG. 10B to FIG. 10D). The crystal zone axes were aligned along [001] to enhance comparability. In the initial state, the bulk atoms are consistent with the edge atoms, and the interlayer spacing is 0.255 nm (FIG. 10B). After 3 cycles, the layer spacing at the edge becomes larger (0.265 nm) than the bulk (0.260 nm). As the depth of the reaction increases, the kinetics of the electrochemical reaction may slow down, resulting in fewer sodium ions being embedded in the inner layers. However, no distortion or deformation of the crystal planes is observed (FIG. 10C). After 100 cycles of thorough activation, the interlayer spacing increases (0.265 nm), but no distortion or deformation of the crystal planes is observed (FIG. 10D). When extending the observation to other particles, a similar phenomenon is noted (FIG. 11 and FIG. 12). This observation concludes that the dissolution of transition metal ions is primarily attributed to unstable Fe⁴⁺ capturing solvent electrons to weaken the Fe—O bond and the effect of the produced HF, rather than the structural distortions and deformation occurring during the electrochemical reaction. Thus, the most effective approach is to configure the electrolyte composition by incorporating specific additives.

### Example 3: Screening Methodology and Standardization of Electrolyte Additives

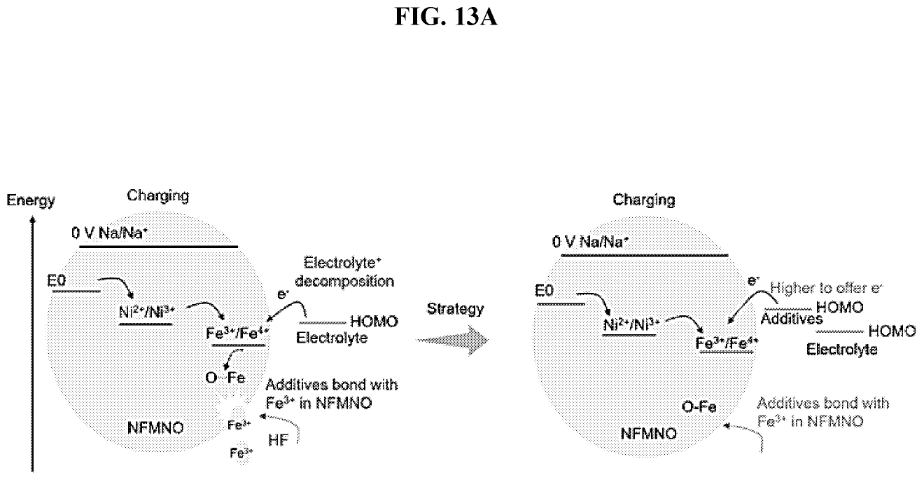

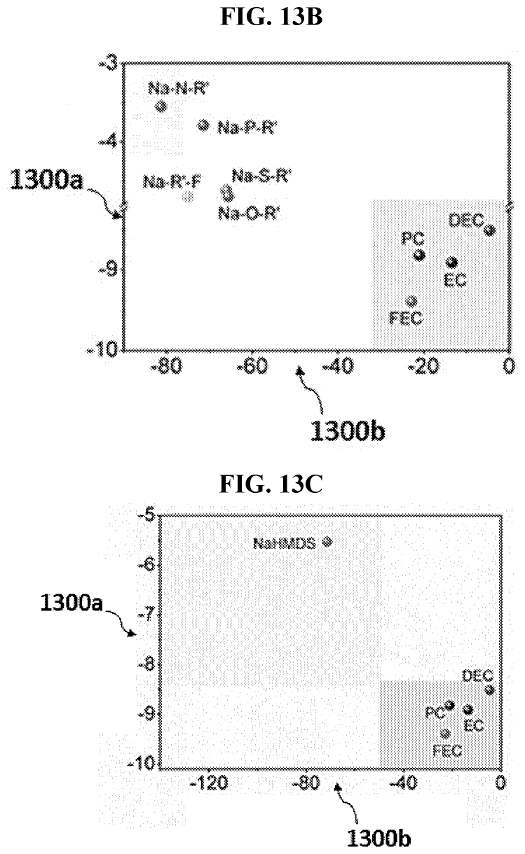

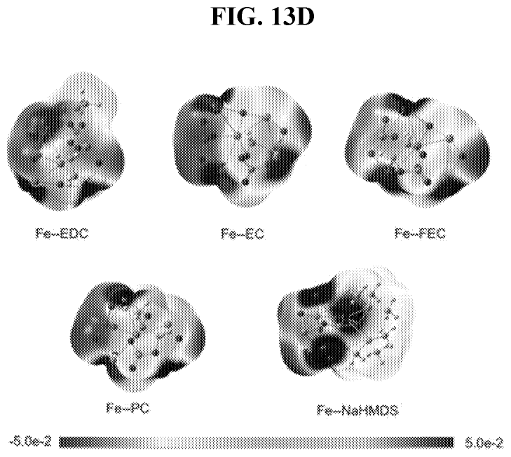

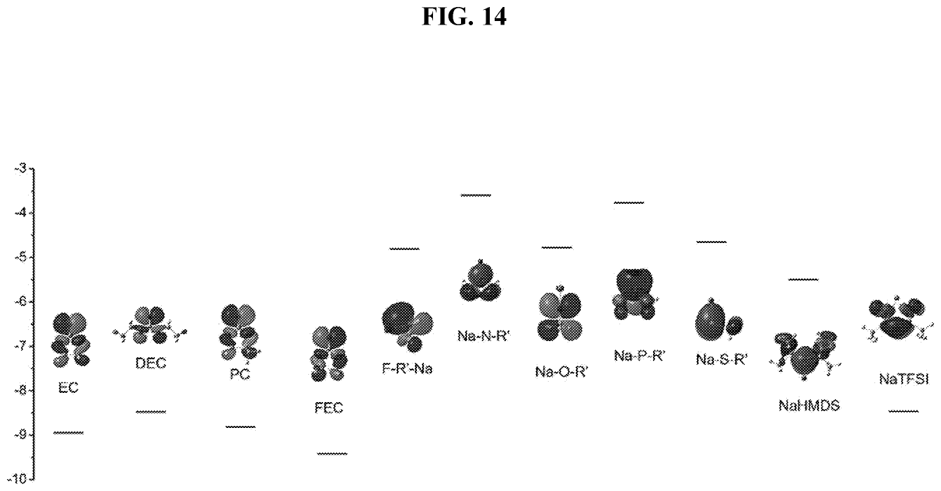

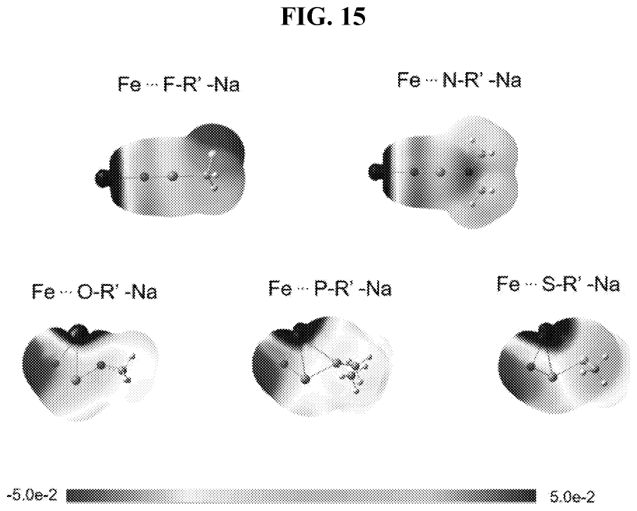

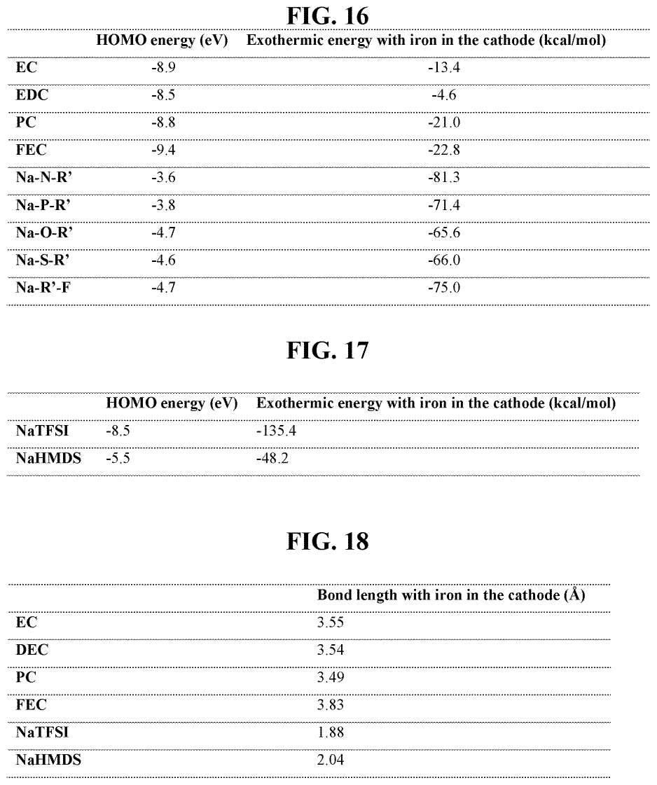

Based on the above experimental results, the developed strategies involve regulating the electrolyte composition to establish a stable interface. Among them, the most effective approach is to configure the electrolyte composition by incorporating specific additives. The additive satisfies the following two conditions: 1) Kinetically: it should be capable of bonding with iron ions in NFMNO; 2) Thermodynamically: its electron-donating ability surpass that of the various solvents in the electrolyte, indicated by a higher HOMO energy compared to the solvents (FIG. 13A). Density functional theory (DFT) calculation simulations were conducted. The HOMO energy of nitrogen (Na—N—R′)-, sulfur (Na—S—R′)-, oxygen (Na—O—R′)-, fluorine (Na—F—R′)-, phosphorus (Na—P—R′)-containing sodium salt additives, solvents in the electrolyte (EC, DEC, PC, FEC), and their interactions with iron in the NFMNO were systematically compared (FIG. 14 and FIG. 15). It was found that among all the above compounds, the nitrogen-containing sodium salt exhibited the highest HOMO energy (−3.55 eV), and the largest exothermic energy (−81.3 kcal/mol) with iron ions in NFMNO (FIG. 13B and FIG. 16). This indicates that the nitrogen-containing Lewis base compounds are the preferred additive. Focusing on nitrogen-containing Lewis base sodium salts, 61 compounds were screened through the Reaxys database (FIG. 1). The compounds are divided into three categories: amino sodium salt (C₂F₆NNaO₄S₂ and F₂NNaO₄S₂), imine sodium salt (C₆H₁₈NNaSi₂), and cyclic derivatives (C₂H₃N₃Na and C₁₉H₁₇N₂NaO₄S). Considering the price and stability during the electrochemical reaction, C₆H₁₈NNaSi₂ (a compound, which is traditionally not used as a sodium-ion battery additive) is selected. Further verification of DFT is carried out, firstly, the HOMO energies of NaHMDS is −5.5 eV, which is higher than those of the solvent molecules. Secondly, the exothermic energy between NaHMDS and the iron in the NFMNO exceeds that of the interaction between solvent molecules and iron in the NFMNO (FIG. 13C and FIG. 17). In addition, the bond lengths of Fe—N in NaHMDS (1.88 Å) are shorter than the Fe-O in the solvent molecules (FIG. 13D and FIG. 18). This theoretical analysis demonstrates that NaHMDS can either donate electrons before solvent molecules or bond to iron ions in NFMNO.

### Example 4: Experimental Verification: the Effect of Additive on Electrolyte, Structure, and Cathode Electrolyte Interphase (CEI)

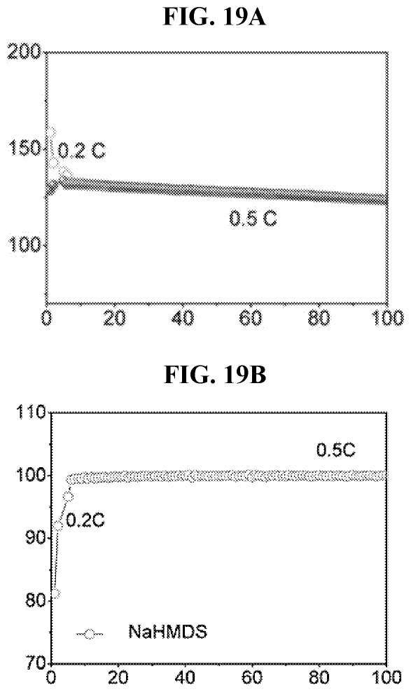

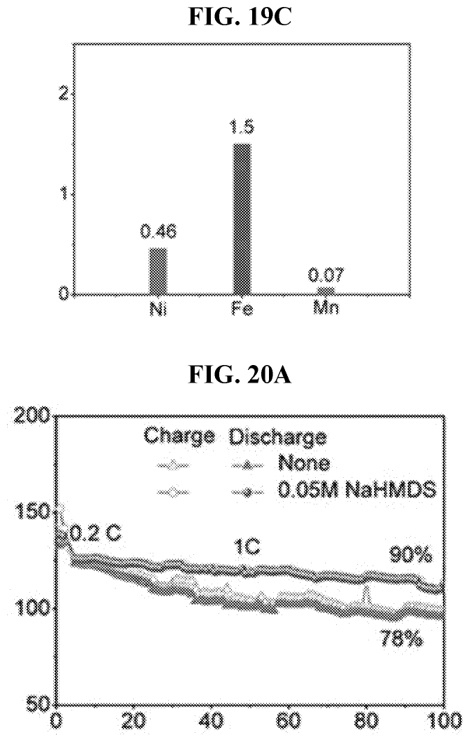

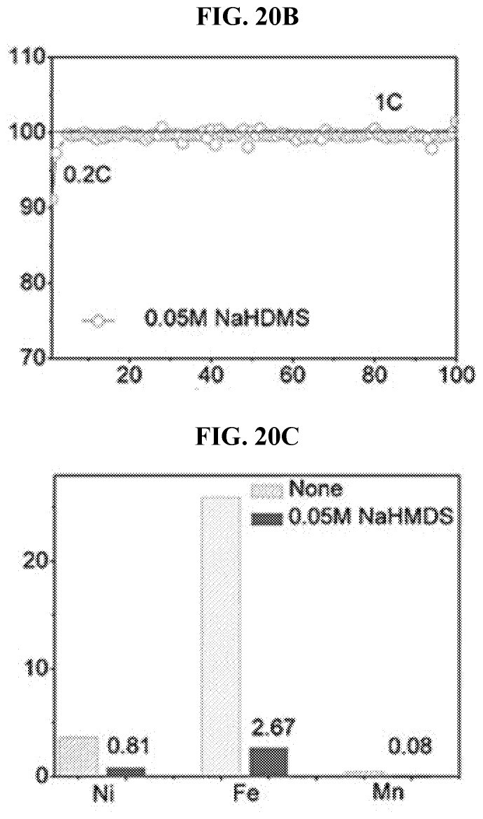

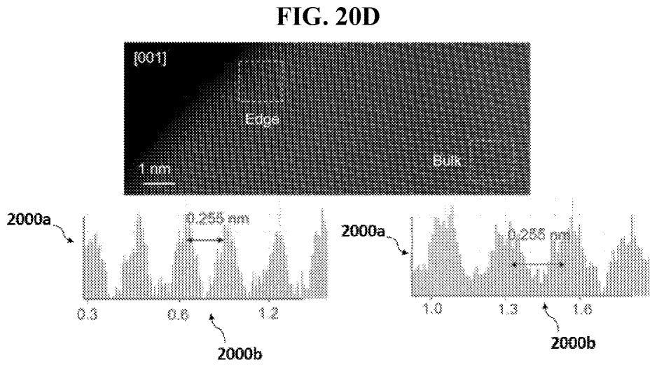

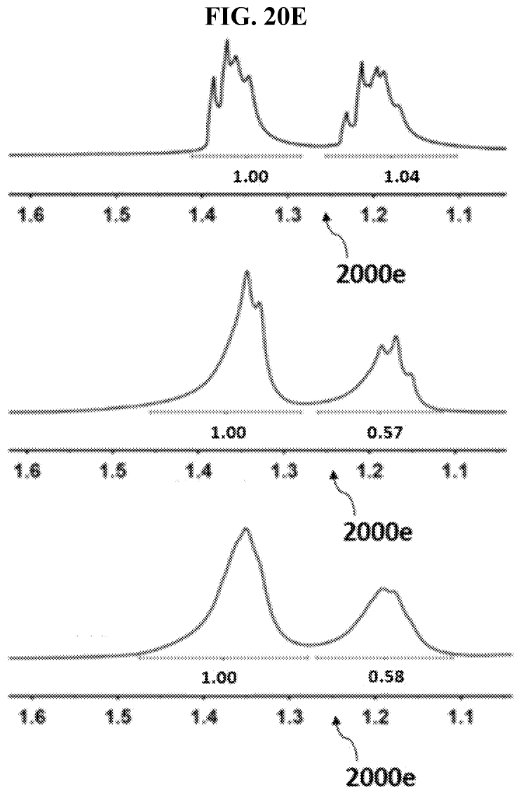

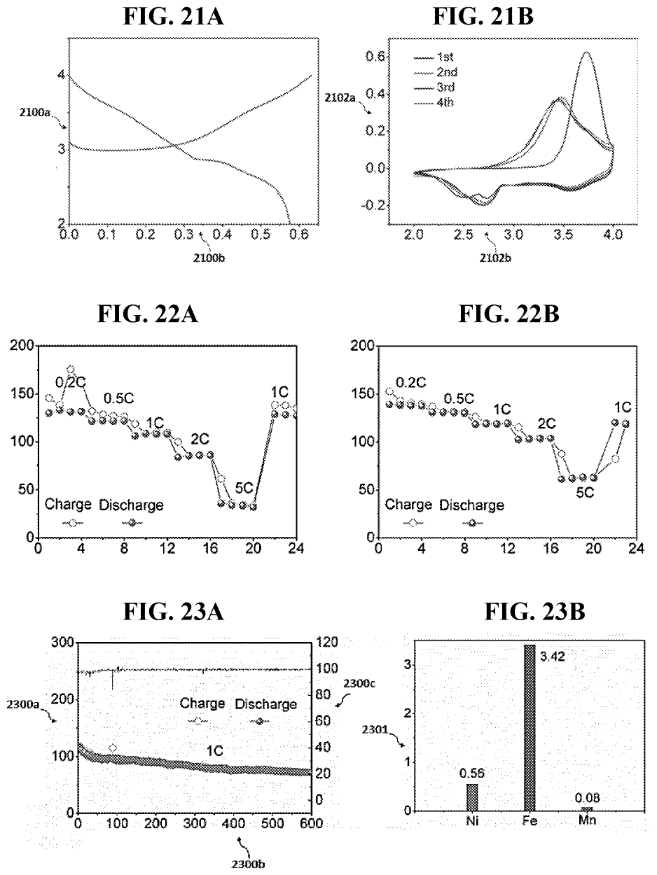

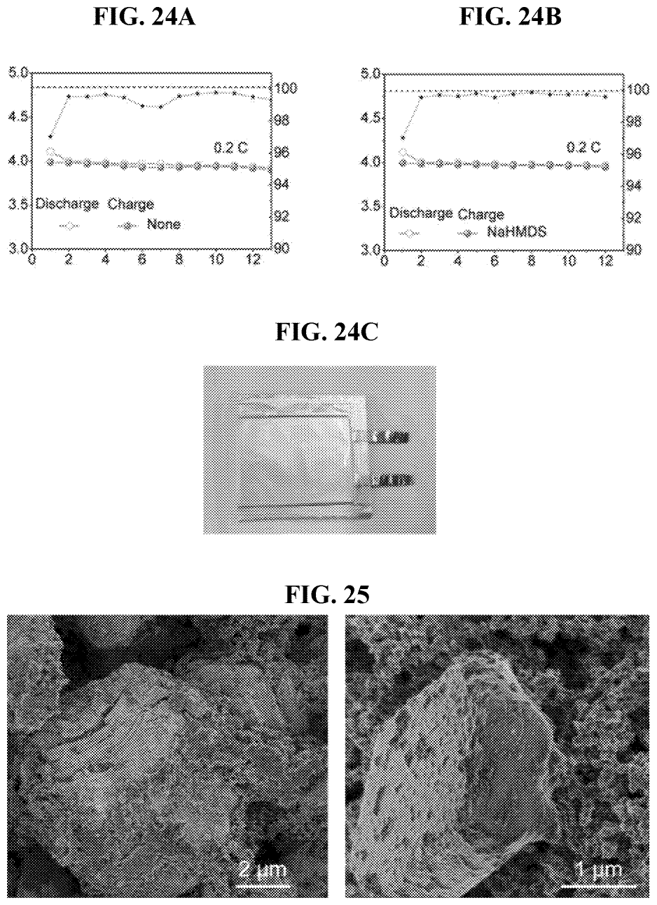

To validate the theory's applicability in guiding experimental procedures, NaHMDS (0.05 M in the electrolyte) was introduced as an additive to the electrolyte, followed by the execution of electrochemical performance tests, the effects of additives on electrolyte composition, structural stability, and CEI. The NFMNO//Na cell utilizing NaHMDS as an additive demonstrates a capacity retention of 93.9% and a Coulombic efficiency of 99.99% after 100 cycles at 0.5 C. Concurrently, the concentration of iron ions in the electrolyte is reduced to 1.5 mg/L (FIG. 19A to FIG. 19C). When the current is increased to 1 C, the capacity retention of 90% and Coulombic efficiency of 99.99% are superior to those observed in the absence of additives (FIG. 20A and FIG. 20B). Furthermore, the concentration of iron ions in the electrolyte is reduced to one-tenth (2.67 mg/L) of the level measured without additives (FIG. 20C). Additionally, in other electrochemical performance metrics, including rate performance and long-cycle performance, the additives have demonstrated beneficial effects (details are in FIG. 21 to FIG. 23). 4 Ah NFMNO//Hard carbon pouch cells were assembled and tested to evaluate their practical feasibility. The results showed that pouch cells incorporating NaHMDS additive achieved Coulombic efficiencies nearing 100% at 0.2 C, surpassing the performance of cells without these additives (FIG. 24A to FIG. 24C). This indeed confirms the effectiveness of the additives we selected.

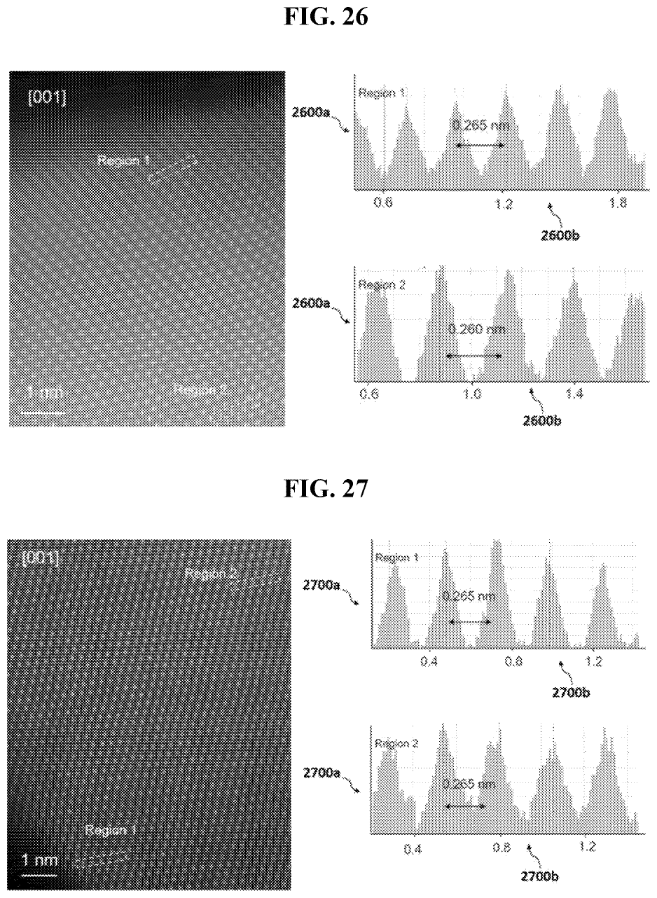

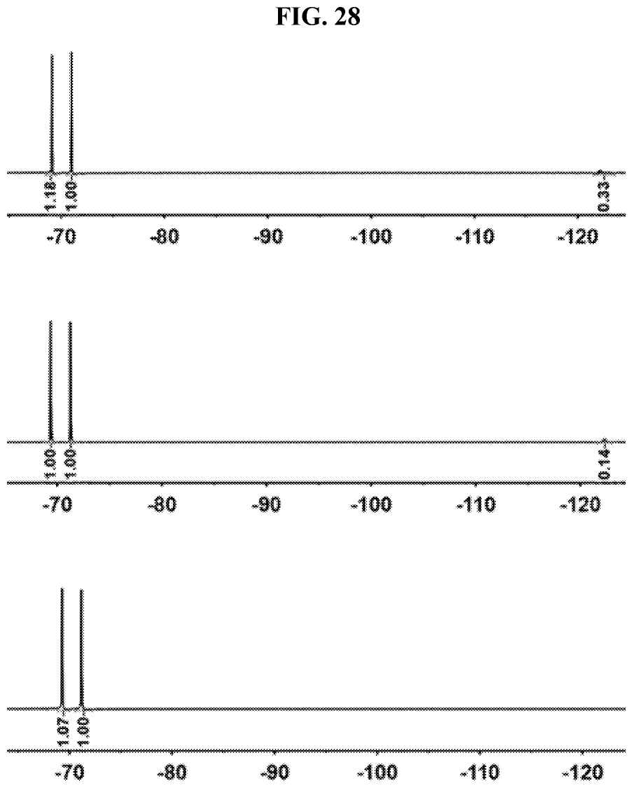

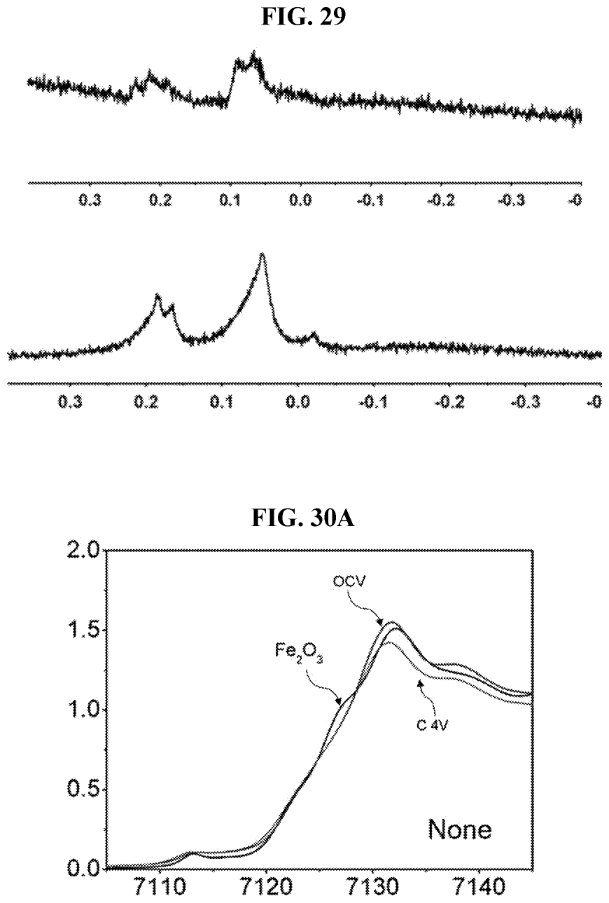

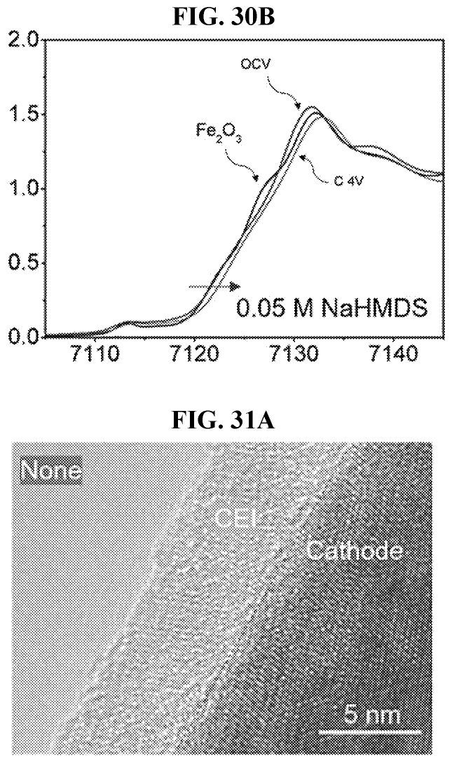

Firstly, in terms of structural analysis, particles with additives exhibit no noticeable surface cracks, in contrast to those without additives (FIG. 25). At a more granular level, there are no observable structural changes at the edges or within the bulk of the particles, and the layer spacing remains consistent after 3 or 100 cycles (FIG. 20D; FIG. 26 and FIG. 27). Secondly, an analysis of the electrolyte composition was performed. ¹⁹F NMR spectra reveal that FEC progressively decreases and is depleted by the 10th cycle, as it participates entirely in forming the CEI film (FIG. 28). ¹H NMR spectra show that DEC diminishes during the first three cycles and contributes to the formation of the CEI film. Notably, unlike in the absence of additives, the DEC content remains stable after 100 cycles, indicating the absence of DEC oxidation (FIG. 20E). The interaction between the NaHMDS additive and iron ions is evident from two experimental observations: (1) the ¹H NMR spectrum of NaHMDS shows changes before and after 100 cycles (FIG. 29), and (2) the valence state of iron increases after 100 cycles, suggesting that Fe⁴⁺ ions do not capture electrons from the solvent but rather coordinate with NaHMDS additives (FIG. 30A and FIG. 30B).

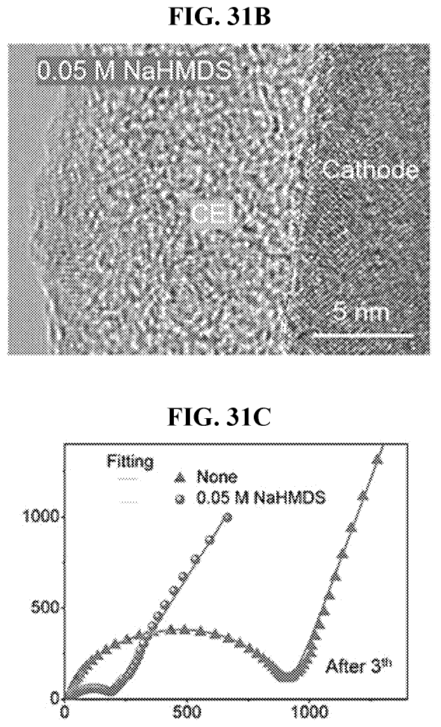

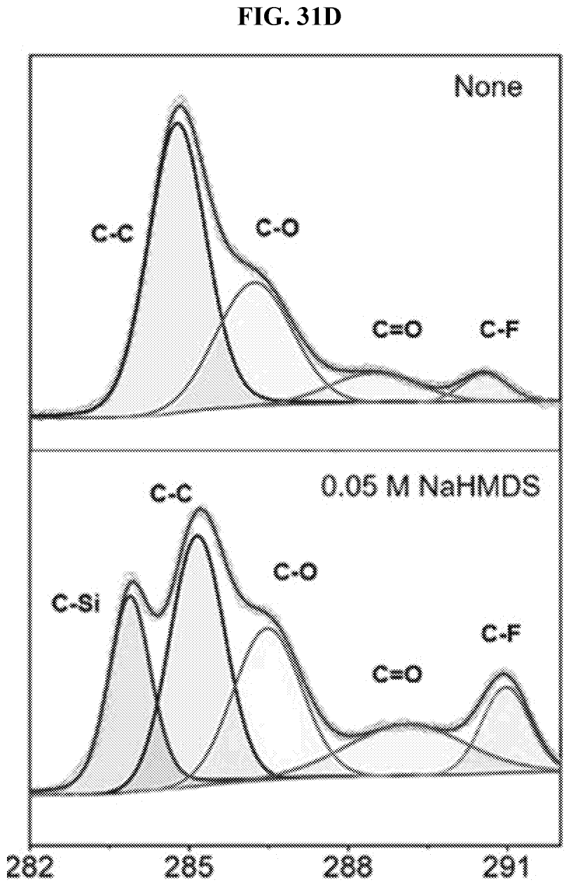

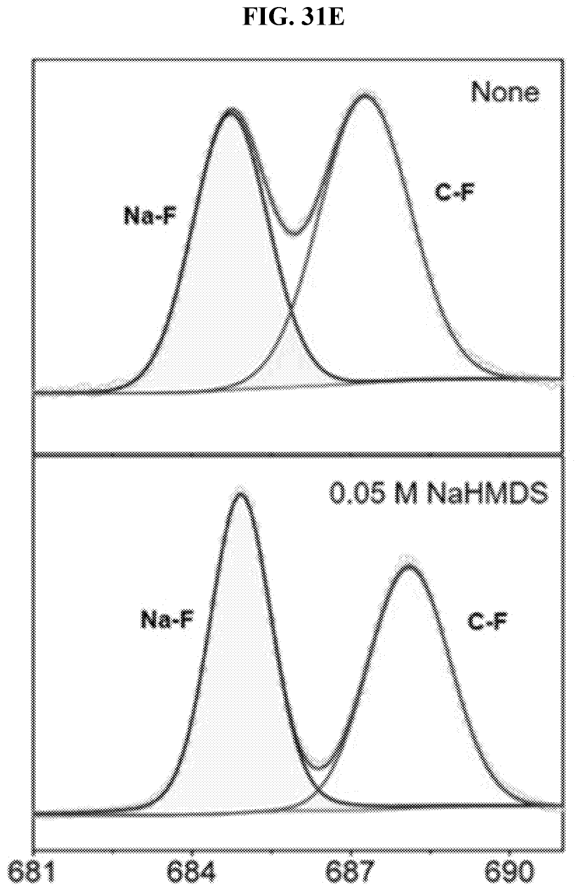

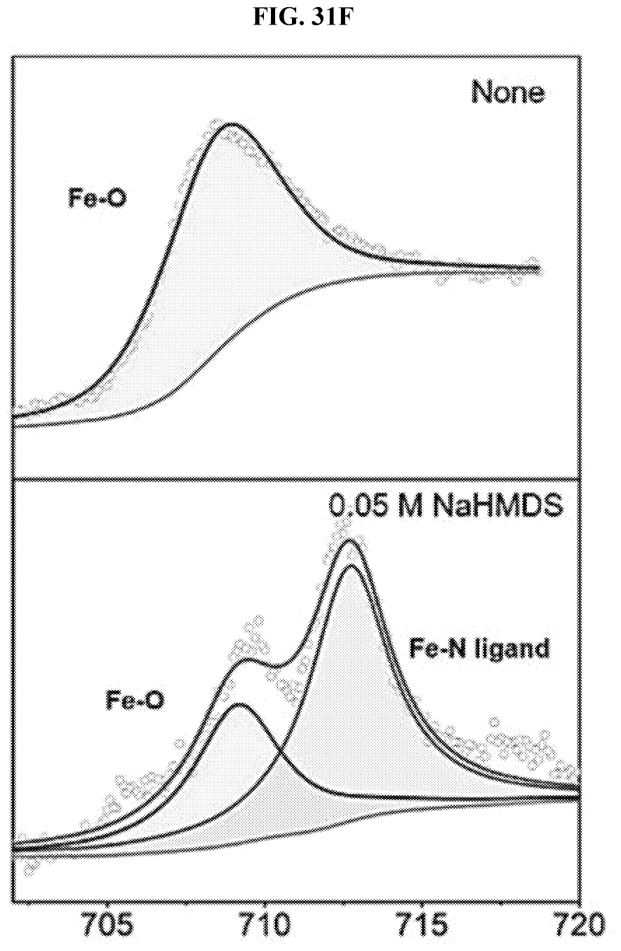

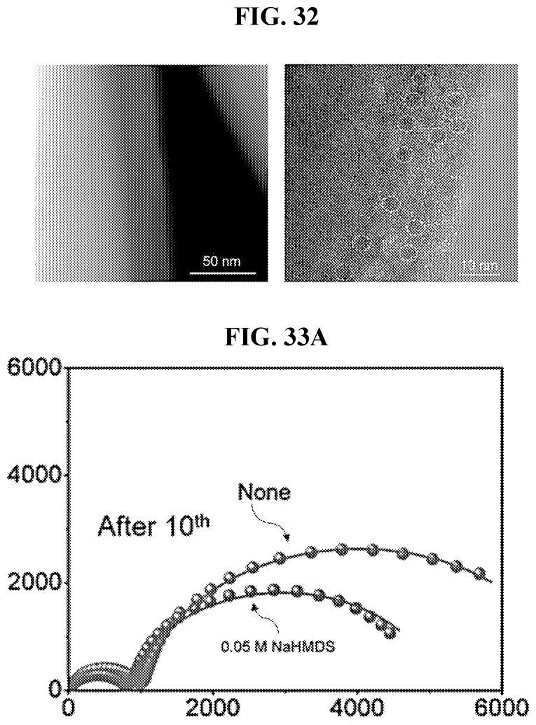

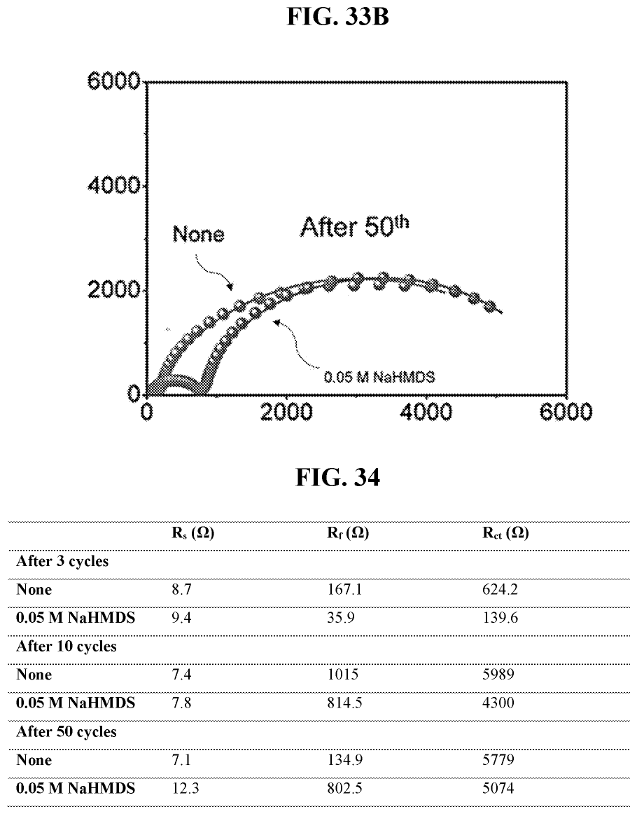

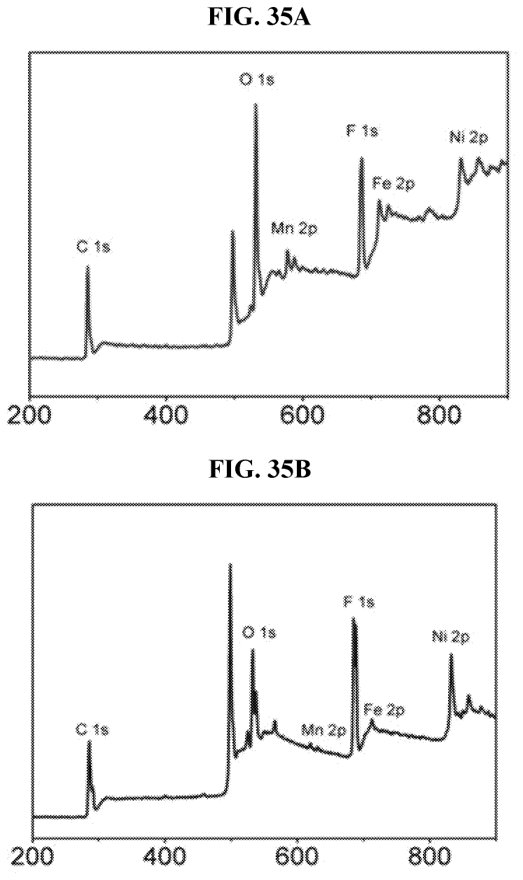

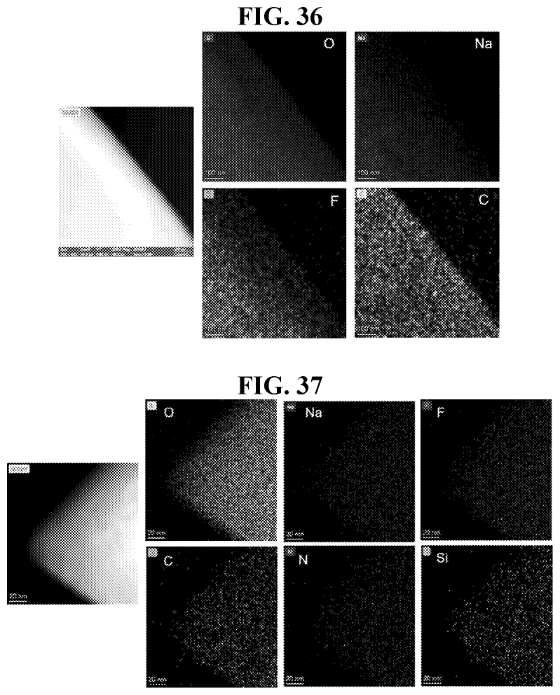

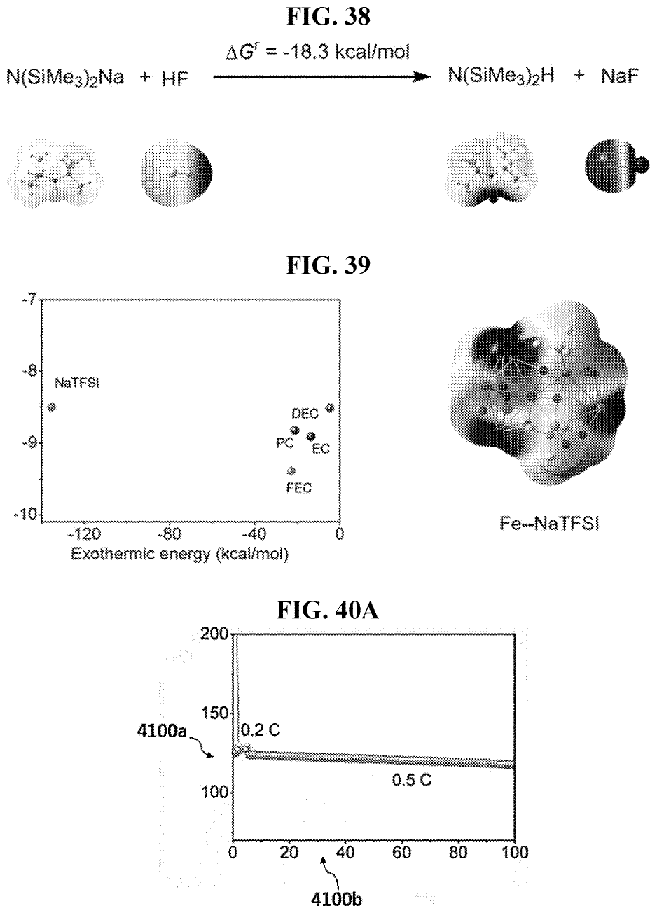

Thirdly, interface differences were examined. The CEI layer without additives measures 6 nm in thickness, whereas the CEI layer with NaHMDS additive measures 12 nm after 3 cycles (FIG. 31A and FIG. 31B), consistent with NMR results. After 100 cycles, the CEI thickness stabilizes at approximately 25 nm, with small inorganic particles uniformly distributed on the surface of the electrodes, which facilitates sodium ion transport (FIG. 32). Electrochemical impedance spectroscopy (EIS) tests and simulations indicate that both the interface layer resistance (R_{f}) and charge transfer resistance (R_{ct}) are lower for systems with additives after 3 cycles (FIG. 31C). After 10 cycles, while R_{f} increases in both cases, the resistance increases more significantly for systems without additives. In contrast, the R_{f} value for systems with NaHMDS additive remains stable after 50 cycles (FIG. 33A, FIG. 33B, and FIG. 34). These results suggest that NaHMDS additives effectively inhibit the oxidative decomposition of the solvent. Compositional analysis of the CEI layer was conducted using XPS (FIG. 35A and FIG. 35B). Compared to systems without additives, the presence of a C—Si peak on the surface of the cathode containing additives (FIG. 31D; FIG. 36 and FIG. 37) indicates that the additives decompose and adsorb onto the cathode material. Additionally, the content of NaF is increased (FIG. 31E), which correlates with the conversion of HF into NaF facilitated by the NaHMDS additive (FIG. 38). Besides Fe—O bonds, the interface with NaHMDS additives also exhibits Fe-N bonds, confirming the ability of the additives to coordinate with iron ions (FIG. 31F). This interaction mitigates the dissolution of iron ions, thereby enhancing Coulombic efficiency and cycle stability.

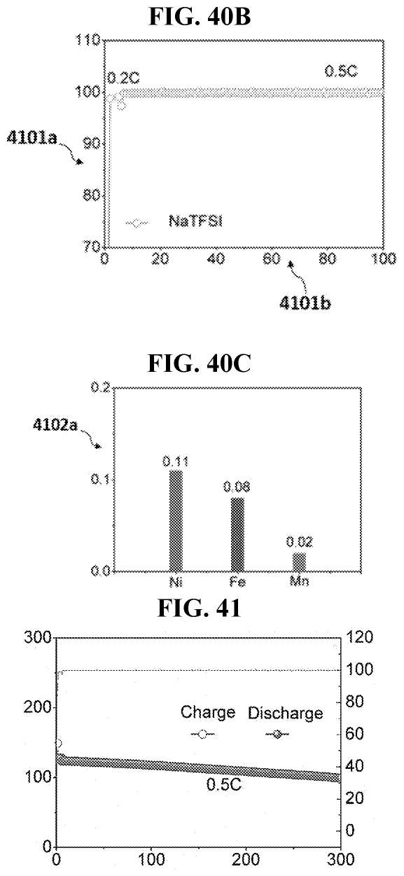

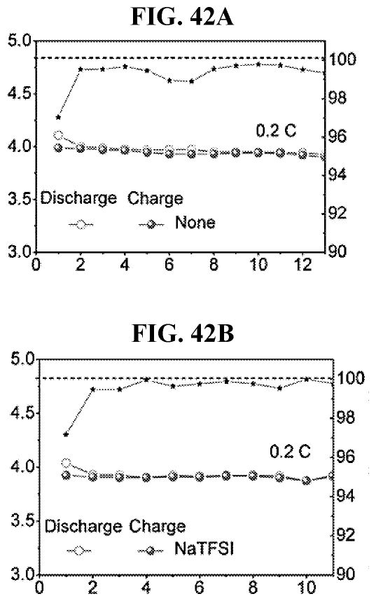

To demonstrate the universality of the screening criteria, sodium bis(trifluoromethylsulfonyl)imide (NaTFSI) was also tested as an additive. The HOMO energies (−8.5 eV), the exothermic energy between NaTFSI and the iron (−135.4 eV) in the NFMNO, and the bond lengths of Fe—N (2.04 Å) indicate that they meet the screening criteria theoretically (FIG. 17 and FIG. 18; FIG. 14 and FIG. 39). The NFMNO//Na cell containing the NaTFSI additive exhibits a capacity retention of 95.1% and a Coulombic efficiency of 99.9% after 100 cycles at 0.5 C. The concentration of iron ions in the electrolyte is 0.08 mg/L, which is significantly lower than the 25.9 mg/L observed in the absence of additives (FIG. 40A to FIG. 40C). The NFMNO//Na cell utilizing NaTFSI as an additive demonstrates a capacity retention of 80% and a Coulombic efficiency of 99.95% after 300 cycles at 0.5 C (FIG. 41). Even in a 4 Ah NFMNO//hard carbon pouch cells, a Coulombic efficiency close to 100% was achieved at 0.2 C with NaTFSI additives, surpassing the performance of cells without additives (FIG. 42A and FIG. 42B). The experimental results of these additives validate the applicability of theoretical predictions in guiding experimental outcomes.

### Example 5: Further Example

The mechanisms underlying capacity fading during cycling in layered oxide cathode materials for sodium-ion batteries remain inadequately understood. The following describe further non-limiting examples of a battery containing an electrolyte of the present disclosure, wherein the battery can serve as an effective strategy for addressing such issue.

The present example is non-limiting and identifies a series of nitrogen-containing Lewis base as electrolyte additives that can kinetically bind efficiently to iron ions in NaFe_{1/3}Mn_{1/3}Ni_{1/3}O₂ cathode and thermodynamically exhibit stronger electron-donating abilities than the solvents.

The battery in various examples can be a sodium-ion battery, comprising: an anode; a cathode, such as NaFe_{1/3}Mn_{1/3}Ni_{1/3}O₂, and an electrolyte comprising a nitrogen-containing Lewis Base additive.

The sodium-ion battery according to various examples, wherein the amount of Lewis Base additive can be 0.5-3 wt % based on the weight of the electrolyte.

The sodium-ion battery according to various examples, wherein the anode can be carbon with disordered lattice, such as various hard carbons and soft carbons.

The sodium-ion battery according to various examples, wherein the cathode is a layered sodium oxide positive electrode comprising transition metals, such as composite transition metals including iron, nickel, manganese, copper, and titanium.

The sodium-ion battery according to various examples, the cathode is made of NaFe_{1/3}Mn_{1/3}Ni_{1/3}O₂.

The sodium-ion battery according to various examples, the Lewis Base is selected from amino sodium salt, imine sodium salt and cyclic derivatives.

The sodium-ion battery according to various examples, wherein the amino sodium salt is selected from C₂F₆NNaO₄S₂ and F₂NNaO₄S₂, imine sodium salt is C₆H₁₈NNaSi₂, and cyclic derivatives are C₂H₃N₃Na and C₁₉H₁₇N₂NaO₄S.

The sodium-ion battery according to various examples, wherein the Lewis Base is sodium bis(trimethylsilyl)amide (C₆H₁₈NNaSi₂).

### Example 6: Summary and Applications

The examples, including the analysis and resolution of the capacity fading mechanism in layered oxide cathodes, are demonstrated. Firstly, the analysis identified that the causes of capacity fading and low Coulombic efficiency are due to the dissolution of transition metal ions and the oxidative decomposition of the solvent. Specifically, the dissolution of iron ions is attributed to the unstable high-valent iron ions and HF rather than structural collapse during the electrochemical reaction. Additionally, the oxidative decomposition of the solvent occurs because the lower energy level of the positive electrode during charging leads to the extraction of electrons from the solvent. Secondly, a class of nitrogen-containing Lewis base additives was identified through theoretical calculations and simulations. These additives share common characteristics: they can coordinate with iron ions and possess greater electron-donating ability compared to solvent molecules, as evidenced by their higher HOMO energy. Thirdly, experimental validation was performed on coin and pouch cells using selected additive molecules, including NaHMDS (new compound) and NaTFSI. These additives enhance the Coulombic efficiency and cycle stability of the battery by mitigating the dissolution of transition metal ions and the decomposition of the solvent molecules. In conclusion, the interface challenge between electrode materials and electrolytes represents the primary obstacle to commercializing sodium-ion batteries. A theoretical screening approach, guiding experimental efforts, can be an effective strategy and may also apply to the analysis of other cathode systems.

While the present disclosure has been particularly shown and described with reference to specific embodiments, it should be understood by those skilled in the art that various changes in form and detail may be made therein without departing from the spirit and scope of the present disclosure as defined by the appended claims. The scope of the present disclosure is thus indicated by the appended claims and all changes which come within the meaning and range of equivalency of the claims are therefore intended to be embraced.

1. An electrolyte for use in a battery comprising:
an electrolyte salt;
a solvent; and
a nitrogen-containing Lewis base additive having a stronger electron-donating ability than the solvent.

2. The electrolyte of claim 1, wherein the nitrogen-containing Lewis base additive comprises an amino sodium salt, an imine sodium salt, or a cyclic nitrogen-containing sodium salt, or a derivative thereof.

3. The electrolyte of claim 1, wherein the nitrogen-containing Lewis base additive comprises sodium bis(trifluoromethanesulfonyl)amide, sodium difluorosulfonylamide, sodium bis(trimethylsilyl)amide, sodium 1,2,4-triazolide, sodium saccharinate, or a mixture thereof.

4. The electrolyte of claim 1, wherein the electrolyte salt comprises sodium hexafluorophosphate, sodium perchlorate, sodium bis(trifluoromethanesulfonyl)imide, sodium bis(fluorosulfonyl)imide, sodium trifluoromethanesulfonate, or a mixture thereof.

5. The electrolyte of claim 1, wherein the solvent comprises an organic solvent.

6. The electrolyte of claim 1, wherein the solvent comprises an organic carbonate-based solvent.

7. The electrolyte of claim 6, wherein the organic carbonate-base solvent comprises ethylene carbonate, dimethyl carbonate, diethyl carbonate, propylene carbonate, fluoroethylene carbonate, ethyl methyl carbonate, or a mixture thereof.

8. The electrolyte of claim 1, wherein the nitrogen-containing Lewis base additive is present in an amount of 0.5 wt % to 5 wt % based on a total weight of the electrolyte.

9. A method for forming the electrolyte of claim 1, the method comprising mixing the electrolyte salt and the nitrogen-containing Lewis base additive in the solvent.

10. The method of claim 9, wherein the solvent comprises an organic carbonate-based solvent.

11. The method of claim 10, wherein the organic carbonate-based solvent comprises ethylene carbonate, diethyl carbonate, and propylene carbonate, mixed in a ratio of 1 to 5:1 to 10:1 to 5.

12. A battery comprising:
an anode;
a cathode comprising sodium and a transition metal oxide, wherein the transition metal oxide comprises iron; and
an electrolyte defined in claim 1.

13. The battery of claim 12, wherein the transition metal oxide further comprises manganese, nickel, copper, or titanium.

14. The battery of claim 12, wherein the cathode comprises NaFe_{1/3}Mn_{1/3}Ni_{1/3}O₂, NaCuFeMnO₂, or NaFeMnNiO₂.

15. The battery of claim 12, wherein the anode comprises carbon, sodium, copper, or aluminum.

16. A method for forming the battery of claim 12, the method comprising:
forming the anode;
forming the cathode;
forming the electrolyte defined in the method of claim 9; and
assembling the anode, the cathode, and the electrolyte configured between the anode and the cathode, to form the battery.

17. The method of claim 16, wherein forming the cathode comprises:
mixing a cathode active material with a conductive agent and a binder in a cathode solvent to form a slurry;
coating the slurry on a current collector; and
drying the slurry coated on the current collector.

18. The method of claim 17, wherein the cathode active material comprises a powder comprising NaFe_{1/3}Mn_{1/3}Ni_{1/3}O₂, NaCuFeMnO₂, or NaFeMnNiO₂.

19. The method of claim 17, wherein the mixing the cathode active material with the conductive agent and the binder comprises:
mixing the cathode active material in an amount more than the conductive agent and/or the binder; and/or
mixing the conductive agent and the binder in an equal amount.

20. The method of claim 17, wherein drying the slurry coated on the current collector comprises subjecting the slurry to vacuum at a temperature range of 60 °C to 120 °C for 6 hours to 24 hours.
